(19) United States
(12) Patent Application Publication
(10) Pub. No.: US 2026/0238967 A1
(43) Pub. Date: Aug. 13, 2026

(54) SYSTEMS AND METHODS FOR OPTIMIZING SENSOR ACTIVATION SCHEDULING IN A DISTRIBUTED SENSOR NETWORK

(71) Applicant: Mitsubishi Electric Research Laboratories, Inc., Cambridge, MA (US)

(72) Inventors: Jianlin Guo, Newton, MA (US); Ananya Hazarika, Cleveland, OH (US); Kieran Parsons, Cambridge, MA (US); Philip Orlik, Cambridge, MA (US)

(73) Assignee: Mitsubishi Electric Research Laboratories, Inc., Cambridge, MA (US)

(21) Appl. No.: 19/049,244

(22) Filed: Feb. 10, 2025

(51) Int. Cl. H04W 4/38; G01D 21/02; G06N 3/092

(52) U.S. Cl. CPC H04W 4/38; G01D 21/02; G06N 3/092

(57) ABSTRACT

A system for optimizing sensor activation scheduling in a distributed sensor network comprises a memory storing computer executable instructions and a processor configured to execute the instructions to receive measurements from sensors monitoring environmental parameters and implement an attention mechanism for computing relevance scores for the plurality of sensors. The processor is further configured to execute a reinforcement learning model to generate activation schedules for the plurality of sensors based on the relevance scores. The reinforcement learning model defines states of the sensors based on the computed relevance scores, sensor energy levels, or historical activation schedules of the sensors. The reinforcement learning model outputs actions representing subsets of sensors to activate at each time step that maximize a reward function that accounts for data quality, energy efficiency, and redundancy minimization. The processor is further configured to transmit activation signals to the selected subset of sensors.

### TECHNICAL FIELD

This disclosure relates generally to collecting data from wireless sensors monitoring the environment, and particularly to collecting data from wireless sensors monitoring the agricultural environment.

### BACKGROUND

Recently, there has been large-scale adoption of devices and sensors in various forms across the world. Several real-world applications now rely on clusters of devices that operate in unison or in tandem with each other to carry out desired functions. For example, in an industrial setup, several devices operate in an intermittent or continuous manner to gather data regarding various machines operating in the industrial set up. Although the proliferation of advanced technologies in connectivity, data processing, and analytics has made devices more connected and accessible than ever before, there are various limitations associated with the use of such advanced technologies. For example, some specialized applications may require clusters of devices to communicate data only for a short duration in a time horizon. As such, it is often desired that such devices turn on or perform some desired functions only when required. The complexity of such requirements is further amplified when such devices are implemented in large numbers such as in an Internet of Things (IoT) setup. Also, in many such applications, owing to size constraints, deployment constraints, and/or environmental constraints, the devices may lack dedicated resources required to implement such advanced communication technologies.

For example, in the agricultural sector, the rise in global food demand and environmental challenges has necessitated the adoption of smart agriculture which is a data-driven approach employing IoT sensor network technology to provide real-time data on various parameters such as soil moisture, temperature, and crop health, optimizing farming practices. In such applications, minimizing energy consumption by the sensors that collect various types of data is often desired. Furthermore, for such applications, it is also desired that the quality of the collected data satisfies some threshold. One solution in this regard includes optimizing sensor activation by determining which sensors to activate based on their relevance and criticality. However, this makes the overall data collection and processing a very complex and challenging task. Also, since applications such as smart agriculture are implemented on a large physical space, it is impractical to connect devices in a wired manner in such applications, which further complicates the data collection and processing requirements.

Accordingly, there is a need for systems and methods for controlling operations of clusters of devices for data collection, processing, and communication such that they can be seamlessly integrated with centralized data processing systems for holistic analysis of the collected data. Additionally, it is also desired that such solutions are secure, scalable, energy efficient, and economical.

### SUMMARY

Various embodiments described herein address the limitations of conventional approaches for controlling clusters of data collection, processing and communication devices in a distributed network. The control of such devices may include selecting the devices that are to be activated, activating one or more such devices, and/or collecting data generated by the one or more activated devices. Some embodiments provide an intelligent device network activation system that leverages attention mechanisms and reinforcement learning for efficient data collection and processing. The system dynamically manages device activation based on the semantic relevance and criticality of the data, reducing redundancy and optimizing energy usage. Various embodiments provide a collaborative sleep scheduling methodology that ensures only the devices that are required are activated, thereby reducing energy and processing requirements of such devices, extending battery life for battery powered devices, and mitigating energy constraints. A central processing module aggregates data from active devices such as sensors, providing a comprehensive view of field conditions and enabling data-driven decision-making. Moreover, the system incorporates communication models designed to operate reliably in various environments, ensuring uninterrupted data transfer. This intelligent approach addresses existing challenges in several real-world applications including smart agriculture, monitoring solar farms for faulty panels, and ensuring safety in mining operations.

Some embodiments are based on the realization that traditional methods for controlling activation of devices from clusters of data collection devices such as sensors and data collection from such devices lack infrastructure such as communication facilities and data processing systems to facilitate efficient and correct processing of data collected from clusters of the data collection devices such as sensors. Furthermore, some embodiments are based on another realization that in several clusters of data collection devices, the devices are mostly battery powered and/or have limited computational resources onboard. As such, while advanced techniques for data collection in multiple modalities exist, they are marred by high power consumption and computational requirements. Additionally, it is also a realization of some embodiments that in several such clusters of data collection devices, redundant data transmission from devices collecting similar information wastes energy and network resources without adding value. The lack of a centralized data processing mechanism limits the ability to analyze information holistically, impairing quick and correct decision-making for large-scale operations.

Accordingly, it is an objective of some embodiments to develop an intelligent and energy-efficient sensor network system that optimizes data collection and processing for large-scale distributed environments such as in smart agriculture. By leveraging advanced techniques like attention mechanisms and reinforcement learning, the system dynamically activates only the most required sensors based on the criticality of the data, minimizing redundancy, conserving energy, and ensuring effective communication.

Several embodiments also provide a data collector unit that dynamically collects the data from the data collection devices such as sensors deployed in an environment and relays the collected data to remote data centers or centralized data processing centers. Some embodiments provide a multi-tier network architecture comprising field data collection devices, at least one data collector unit, and remote data processing centers. According to some embodiments, the data collection devices communicate with the data collection unit using short range communication while the data collection unit communicates with remote data processing centers using long range communication.

To realize the aforementioned objectives, various embodiments are based on postulations and assumptions that redefine how various entities and data are utilized in the system. In this regard, some embodiments recognize that measurements or data collected from the data collection devices can be treated as language; enabling the application of attention mechanisms to place the measurements into context and evaluate redundancy as indicated by the attention scores. For example, where the data collection devices are sensors, each sensor may be treated as a “word” in a sentence and the data provided by the sensor corresponds to the “meaning” of the word. A sequence of measurements from multiple sensors over time forms a “sentence.” Each sequence provides a snapshot of the monitored environment. Some embodiments thus realize that just as words depend on their neighboring words in a sentence for meaning, the importance or criticality of a sensor's measurement depends on the context provided by other sensors used in a task. Accordingly, similar to how language models embed words, some embodiments use feature extraction to convert raw sensor data into embeddings (numerical representations). As an example, for temperature sensors, the data may be embedded with values like measurement value (e.g., temperature reading), temporal trends (e.g., gradient or change over time), and/or sensor metadata (e.g., location, energy level).

Some embodiments utilize attention mechanism to process the data collected from various data collection devices. The attention mechanism is a technique commonly used in machine learning that enables a model to focus on certain parts of the input data that are more relevant to the current task, rather than processing all parts of the data equally. The attention mechanism may be thought of as a way for the model to “pay attention” to important parts of the input when making predictions. Various example embodiments extend the application of attention mechanism to processing data collected by data gathering device such as sensors (hereinafter sensor data), by exploiting the contextual dependency of sensors with each other. Some embodiments provide an attention mechanism-based framework for evaluating the importance of each sensor's data in the context of other sensors. In this regard, the attention mechanism-based framework includes generating attention scores that quantify the relationship between one sensor's data and the data from other sensors in a cluster. The attention mechanism-based framework further includes assessing redundancy to prioritize critical information, based on the attention scores.

Some embodiments perform feature representation by encoding each sensor's data into a key (K), a value (V), and a query (Q), where K represents the context provided by the sensor, V encodes the actual data contribution, and Q represents the overall task or monitoring goal. Some embodiments then compute the attention scores by comparing the query of each sensor with the keys of all sensors to measure relevance, and normalizing the scores to obtain the attention score for each sensor. The sensors with similar attention scores aᵢⱼ for multiple comparisons indicate redundancy. If aᵢⱼ for sensor j heavily depends on sensor i, the data from sensor j may not contribute unique information. Some embodiments also use the attention scores to compute weighted contributions of each sensor in the form of a contextual output that places each sensor's measurement in the context of others, emphasizing unique contributions and reducing redundancy. High attention scores across many sensors indicate that multiple sensors are contributing highly correlated or overlapping data, which corresponds to redundancy. Diverse attention scores on the other hand indicate that some sensors provide data that is distinct and critical to the overall system, which reflect uniqueness.

Some embodiments quantify redundancy by computing a redundancy metric from the attention scores. Reinforcement learning (RL) is then applied to determine the optimal schedule for sensor activation. The RL framework comprises computing the attention scores ai for all sensors based on redundancy and uniqueness, constructing states, actions, and reward function using the attention scores, simulating sensor activations and iteratively updating an RL policy, and using the trained RL policy to dynamically schedule sensor activations based on real-time attention scores and system states.

With such a framework, the attention mechanism ensures only non-redundant sensors with critical data are prioritized. RL optimizes the activation schedule to balance coverage and energy use. As another advantage, such a framework for sensor activation and operation works with large sensor networks by dynamically adjusting schedules.

Some example embodiments are directed towards large scale sensor activation and data collection from clusters of the sensors for field applications such as smart agriculture. In this regard, some embodiments provide an unmanned aerial vehicle-assisted field network architecture, in which one or more unmanned aerial vehicles (UAVs) act as data collectors in a dynamic communication infrastructure to collect and relay field (agriculture) sensor data to remote data centers. Some embodiments provide a two-tier network architecture to realize smart agriculture, where no conventional communication infrastructure is needed. The two-tier network architecture comprises a plurality of stationary field sensors, data collectors and cloud data servers, where the data collectors are widely available and may be used to replace communication infrastructure. The field sensors and data collectors form first-tier networks to transfer sensor data from field sensors to one or more data collectors, and the one or more data collectors and one or more cloud servers form second-tier networks to relay the collected sensor data to the one or more cloud servers for data processing. In this architecture, sensors and data collectors may communicate using short range communication technology, and the data collectors and the cloud servers may communicate using long range communication technology.

Some embodiments are further based on the realization that conventional machine learning approaches fail to capture the semantic importance of sensor measurements and their contextual relationships. Large language models (LLMs) are machine learning models that generate language and process other language tasks. Some embodiments utilize LLMs to generate semantic labels for agriculture data, which may be used in data collection by waking up sensors that have useful data and having the rest of sensors sleep for energy consumption.

Accordingly, some embodiments provide a large language model (LLM) based approach for context-aware semantic mapping, by introducing a redundancy index (RI) that indicates similarity of a sensor's contributions with respect to other sensors and a novel semantic criticality index (SCI) that assesses the importance of agricultural sensor data. An attention-based method is provided to compute RIs and SCIs for sensors. RIs and SCIs are used for energy efficient sensor data collection, which is formulated as an optimization problem and solved by a Semantic-Guided Deep Q-Network (SG-DQN) algorithm, a reinforcement learning algorithm that optimizes energy consumption and resource allocation based on semantic context.

Accordingly, one embodiment discloses a computer-implemented method for optimizing sensor activation scheduling in a distributed sensor network. The method comprises receiving input data from a plurality of sensors distributed across a monitored area, wherein each sensor provides measurements of one or more environmental parameters. The input data is represented as feature vectors, wherein each feature vector includes sensor-specific attributes including one or a combination of measurement values, semantic criticality, redundancy index, spatial metadata, temporal trends, sensor energy level, and operational characteristics. The method further comprises applying an attention mechanism to the feature vectors. The attention mechanism is applied to the feature vectors compute attention scores for each sensor by comparing sensor-specific feature vectors to a global context vector using a similarity function. The attention mechanism is further applied to the feature vectors to compute redundance index for each sensor from attention scores to access its overlap with sensors. The attention mechanism is further applied to the feature vectors to generate a semantic criticality index for each sensor indicating its criticality to the monitoring objective. The method further comprises executing a reinforcement learning model to determine an optimal activation schedule using redundance index and semantic criticality index for the sensors. The reinforcement learning model defines states of the plurality of sensors based on the computed relevance scores, sensor energy levels, or historical activation schedules of the plurality of sensors. The reinforcement learning model outputs actions representing subsets of sensors to activate at each time step that maximize a reward function that accounts for data quality, energy efficiency, and redundancy minimization. The method further comprises activating a selected subset of sensors based on the output of the reinforcement learning model. The method further comprises iteratively updating the attention mechanism and reinforcement learning model using feedback from sensor performance and collected data to improve scheduling efficiency.

In yet another example embodiment, a system for optimizing sensor activation scheduling in a distributed sensor network is provided. The system comprises a memory configured to store historical sensor data, learned policies, system parameters, and computer executable instructions and a processor configured to execute the instructions. The system further comprises a plurality of sensors configured to monitor environmental parameters and transmit measurements. The processor is configured to implement an attention mechanism for computing relevance scores for the plurality of sensors. The processor is further configured to execute a reinforcement learning model to generate activation schedules for the plurality of sensors based on the relevance scores. The reinforcement learning model defines states of the plurality of sensors based on the computed relevance scores, sensor energy levels, or historical activation schedules of the plurality of sensors. The reinforcement learning model outputs actions representing subsets of sensors to activate at each time step that maximize a reward function that accounts for data quality, energy efficiency, and redundancy minimization. The processor is further configured to transmit activation signals to the selected subset of sensors.

### BRIEF DESCRIPTION OF DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A illustrates a block diagram of a system for optimizing sensor activation scheduling in a distributed sensor network, according to some embodiments;

FIG. 1B illustrates a flowchart of a method for optimizing sensor activation scheduling in a distributed sensor network, according to some embodiments;

FIG. 1C shows an operational environment of a cluster of sensors and a data collector unit collecting the data from the sensors, according to some embodiments;

FIG. 2A shows an example of clustering of sensors deployed in a field, according to some embodiments;

FIG. 2B is a schematic illustrating a two-tier network architecture for a data acquisition and processing system, according to some embodiments;

FIG. 3 shows a framework for sensor data collection and processing, according to some embodiments;

FIG. 4A shows an example of a first-tier network with one UAV and N sensors of the two-tier network architecture, according to some embodiments;

FIG. 4B shows an example of communication connectivity between a UAV and sensors in the first-tier network at time T1, according to some embodiments;

FIG. 4C shows an example of communication connectivity between a UAV and sensors in the first-tier network at time T2, according to some embodiments;

FIG. 5A depicts sensor data collection periods in a smart agriculture system, according to some embodiments;

FIG. 5B demonstrates the structure of a data collection period for a sensor cluster, according to some embodiments;

FIG. 5C demonstrates the structure of a data collection interval for an individual sensor, according to some embodiments;

FIG. 5D shows an example structure of a data collection interval for a sensor cluster, according to some embodiments;

FIG. 6A illustrates an example of the sensors in a sensor cluster that are scheduled for data collection at time T1, according to some embodiments;

FIG. 6B illustrates an example of the sensors in a sensor cluster that are scheduled for data collection at time T2, according to some embodiments;

FIG. 7 shows an LLM-based semantic labeling algorithm for collecting agriculture data, according to some embodiments;

FIG. 8 illustrates the training phase of a Semantic-Guided Deep Q-Network algorithm, according to some embodiments; and

FIG. 9 illustrates some components of a system for optimizing sensor activation scheduling in a distributed sensor network, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a FIG. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

### Overview

There are a large number of devices presently in use that capture data in one or the other form. Several applications utilize multiple such devices for gathering data regarding the state of devices, environment or to obtain measurements of physical quantities. Due to several reasons, in some specialized applications, it may be desired that only a select few such devices be activated at a certain point in time. Some examples of such specialized applications include smart agriculture, mines and quarries, solar farms and any large-scale implementation of such data capturing devices in large numbers. One example of such data capturing devices includes sensors.

Some embodiments are based on the realization that sensor measurements can be treated as language, enabling the application of attention mechanisms to place measurements into context and evaluate redundancy and criticality as indicated by the attention scores, wherein each sensor can be treated as a “word” in a sentence and the data it provides corresponds to the “meaning” of the word and represents its semantic contribution, wherein a sequence of measurements from multiple sensors over time forms a “sentence” providing a snapshot of the monitored environment.

Field applications such as smart agriculture have become a necessity as the global demand for food continues to rise alongside growing environmental concerns. Efficient and scalable data collection from vast agricultural landscapes is critical for monitoring soil health, crop conditions, and other key parameters that influence productivity. However, achieving this requires overcoming challenges such as limited sensor battery life, unreliable communication infrastructure in rural areas, and the need to process large amounts of data from heterogeneous sources. These constraints necessitate the development of intelligent systems capable of optimizing sensor activation, ensuring energy efficiency, and enabling seamless data transmission and analysis.

Some embodiments recognize that the implementation of smart agriculture systems faces several significant challenges that limit their efficiency and scalability. One limitation is the lack of infrastructure in rural or remote areas, where essential facilities such as communication networks and data processing platforms are either unavailable or unreliable, impeding the seamless integration of sensors and data analytics. Additionally, it is realized that many agricultural sensors, particularly those deployed underground or in expansive fields, are constrained by energy availability. While some advanced sensors can harvest renewable energy, they are often cost-prohibitive for large-scale deployment, necessitating the use of energy-efficient designs and collaborative sleep scheduling mechanisms to extend battery life.

Furthermore, embodiments identify that redundant data collection from multiple sensors capturing similar environmental parameters leads to unnecessary energy consumption and inefficient bandwidth usage, which is especially problematic in resource-limited scenarios. Memory limitations in agricultural sensors also present a challenge, as sensors typically have insufficient capacity to store large volumes of data. This necessitates the prompt transfer of collected data to centralized processing systems to avoid memory overflow and loss of valuable information. Additionally, communication links in rural regions can be disrupted by physical barriers like crops or adverse weather conditions, further complicating reliable data transmission and processing. These limitations underscore the need for intelligent, adaptive, and cost-effective solutions to enable the practical realization of smart agriculture.

In order to overcome the aforementioned challenges and enable efficient and intelligent smart agriculture, some example embodiments employ a novel system that integrates semantic contextual intelligence, reinforcement learning (RL), and attention mechanisms. The framework dynamically identifies critical data collection requirements and triggers specific sensors or data collection units based on environmental conditions, energy availability, and data relevance. The attention mechanism evaluates sensor-specific feature vectors, calculating Redundancy Index (RI) to assess overlap among sensors and Semantic Criticality Index (SCI) to prioritize sensors based on their importance to monitoring objectives. These scores guide the reinforcement learning model, which dynamically determines optimal activation schedules for subsets of sensors. The reinforcement learning model defines states based on relevance scores, sensor energy levels, and historical activation data, and outputs activation actions that maximize a reward function focused on data quality, energy efficiency, and redundancy minimization. Iterative feedback from sensor performance and collected data enhances the model's adaptability, ensuring reliable and resource-efficient sensor operation across diverse environments and large-scale deployments.

### Sensor Activation System and Method

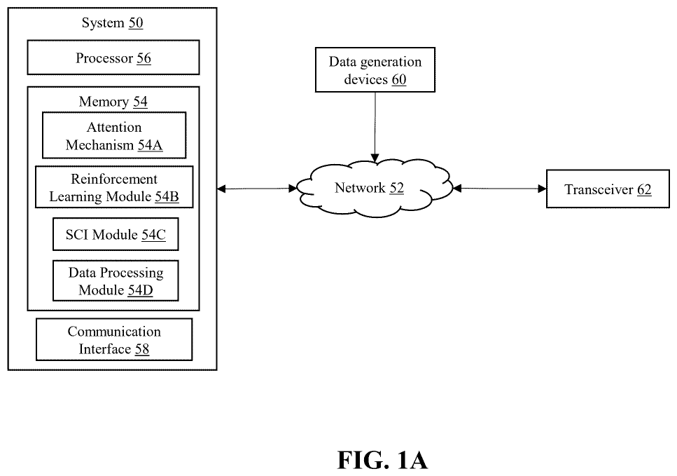

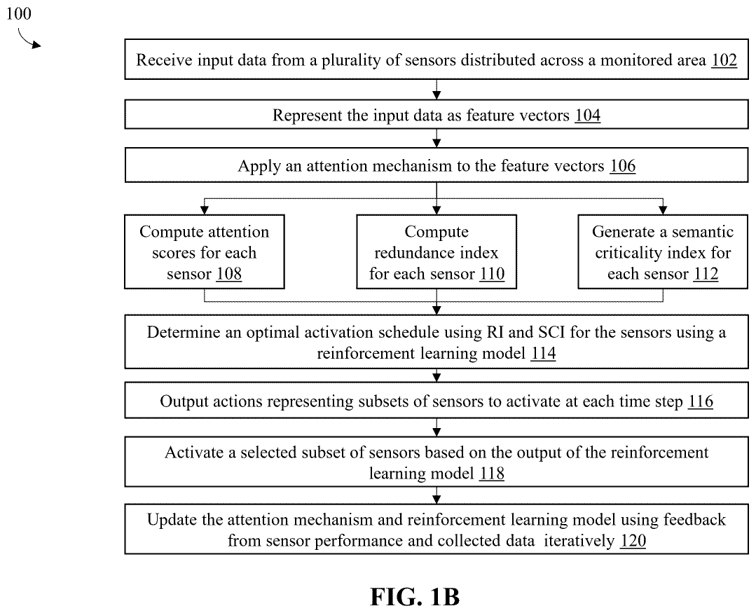

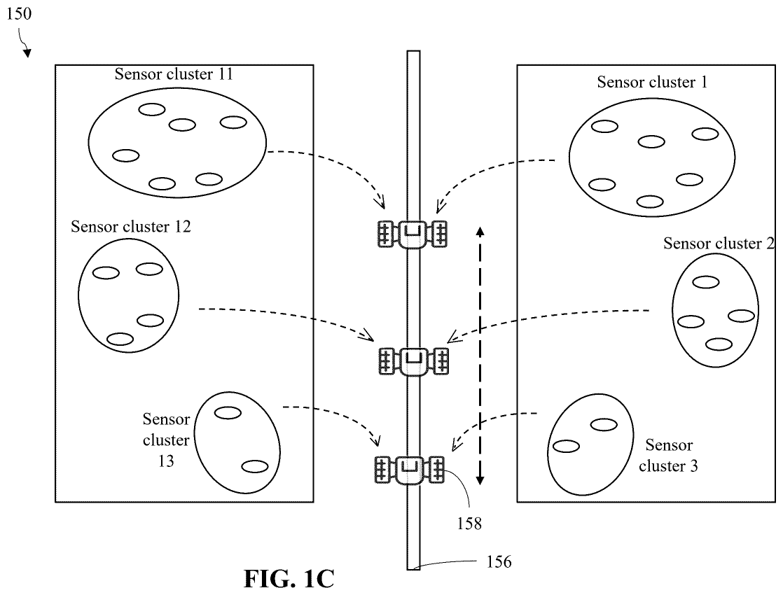

FIG. 1A illustrates a block diagram of a system 50 for optimizing sensor activation scheduling in a distributed sensor network, according to some embodiments. The system 50 is coupled through network 52 to one or more other components such as data generation devices 60 and a transceiver 62. The memory module 54 stores the data hosting specialized modules that drive the intelligence of the system.

The memory 54 may store instructions that are executable by the system and any data that may be utilized by the methods and systems of the present disclosure. The memory 54 may include random access memory (RAM), read only memory (ROM), flash memory, or any other suitable memory systems. The memory 54 may be a volatile memory unit or units, and/or a non-volatile memory unit or units. The memory 54 may also be another form of computer-readable medium, such as a magnetic or optical disk.

The memory 54 further includes an attention mechanism module 54A, a reinforcement learning (RL) module 54B, a Semantic Criticality Index (SCI) module 54C, and a data processing module 54D. The attention mechanism module 54A evaluates sensor-specific feature vectors to compute RI and SCI scores, identifying data criticality and redundancy. The attention mechanism module 54A generates attention scores using a transformer-based architecture with multi-head attention to evaluate multiple aspects of sensor relevance, including spatial coverage, temporal variability, and correlation with neighboring sensors. The RL module 54B leverages these scores to optimize sensor activation schedules dynamically, balancing energy efficiency with data relevance. The SCI module 54C computes a criticality index for each sensor. This index quantifies the importance of each sensor to the monitoring objectives, helping prioritize sensors that are most critical for the success of the monitoring task. The SCI module 54C analyzes factors such as data quality and relevance in the context of the agricultural environment. The data processing module 54D aggregates and processes data from various sensors and data collection units, providing actionable insights to stakeholders.

Processor 56, a key component of the smart agricultural system, is responsible for executing instructions and performing computations. The processor 56 processes data received from data generation devices 60, which include sensors and devices that monitor environmental conditions such as temperature, humidity, and soil moisture. The data generation devices 60 analyze this data and use it to optimize various aspects of agricultural processes. The processor 56 runs machine learning models, including Large Language Models (LLM), to identify patterns, make predictions, and improve decision-making. For instance, the processor 56 computes optimal activation schedules for sensors or data collection units by considering factors like redundancy, criticality, and energy efficiency. Furthermore, the processor 56 also manages the data collection units (e.g., UAV's flight paths, resource allocation, and crop management operations) based on the analyzed data. The processor 56 drives the intelligence of the smart agricultural system, executing the RL, SCI and attention algorithms and facilitating real-time decision-making.

The data generation devices 60 collect real-time data from the environment. The data generation devices 60, which include a variety of sensors deployed in the field, generate real-time data on parameters such as soil moisture, temperature, and air humidity. The transceiver 62 serves as a data collection unit and may be embodied by vehicles, poles, tree-attached machines, or drones (UAVs), ensuring that this real-time data is relayed to the processor 56 for processing and decision-making. The data collection unit plays a role in bridging the gap between the data generation devices 60 and the central processor, ensuring that data is continuously monitored and acted upon in a timely manner.

The transceiver 62 performs wireless communication between the various components of the smart agriculture system. The transceiver 62 is embodied by data collection units, which may take various forms depending on the specific application. These data collection units may include mobile vehicles, autonomous robots, fixed robots for fixed poles or stations placed in the soil, and machines attached to trees or other structures within the field. Additionally, UAVs (Unmanned Aerial Vehicles) or drones may serve as dynamic transceivers by collecting data from remote sensors and transmitting it to the central processor. The data collection units act as communication relays, ensuring that data generated by sensors deployed in the agricultural environment is wirelessly transmitted to the processor for analysis. The transceiver 62 enables the flow of real-time data as well as supports bi-directional communication, allowing the processor 56 to send control commands to the sensors or other devices for activation, deactivation, or adjustment based on current environmental conditions or monitoring needs.

Communication interface 58 enables connectivity between the system and external networks, IoT devices, or cloud services. The communication interface 58 facilitates the transmission of data, receipt of commands, and communication with external controllers or monitoring systems. The communication interface 58 operates through the network 52, which connects all components, enabling efficient data flow from the data generation devices 60 to the processor 56 and the various modules within the memory 54. The network 52 ensures that all components may communicate with external systems or services for optimized decision-making and management of agricultural processes.

The network 52 allows the smart agricultural system's components, such as transceivers 62, processor 56, data generation devices 60, and memory 54, to communicate effectively over a wireless or wired network. The network 52 may be implemented using a variety of technologies to suit different operational contexts. Wired networks, such as Ethernet or fiber optic connections, are ideal for stationary or highly secure installations, offering high-speed and reliable communication. Conversely, wireless networks, including Wi-Fi, 5G, Zigbee, LoRaWAN, and satellite communication, provide flexibility and scalability for mobile or remote operations. The network 52 may include hardware components such as modems, Wi-Fi transceivers, or other communication devices responsible for establishing a connection to the wider network, enabling data transmission. Software within the network 52 may be responsible for packetizing and de-packetizing data for network communication or managing communications over a cloud-based platform. In some embodiments, the network 52 combines control and forwarding functions on the same physical hardware, while in other cases, these functions might be split, with the control functions managed by external network devices in configurations such as software-defined networking (SDN). The network 52 ensures that data generated by environmental sensors or collected by data collection units and data collection units is transmitted to the processor or external systems for analysis.

FIG. 1B illustrates a flowchart of a method 100 for optimizing sensor activation scheduling in a distributed sensor network, according to some embodiments of the present disclosure. FIG. 1B is described with reference to one or more elements from FIG. 1A. According to some embodiments, the method 100 may be executed by the system 50 of FIG. 1A. Referring to FIG. 1B, at step 102, the method 100 comprises receiving input data from a plurality of sensors distributed across a monitored area. These sensors, which may include soil probes, UAV-based devices, and environmental monitoring units attached to trees or poles, collect measurements of various environmental parameters such as temperature, humidity, soil moisture, and air quality. The collected data is transmitted via a communication interface to a processing unit, where it is represented as feature vectors which is mentioned as step 104. Each feature vector encapsulates sensor-specific attributes, including measurement values, redundancy index, spatial metadata, temporal trends, energy levels, and operational characteristics. These representations provide a structured format for further analysis.

Once the data is structured into feature vectors, at step 106 an attention mechanism is applied to the feature vectors within the processor. This mechanism evaluates the importance of each sensor in contributing to the monitoring objectives. Attention scores are computed for each sensor 108 by comparing individual sensor feature vectors to a global context vector using a similarity function. This process identifies sensors that are most relevant to the current monitoring context. The system also computes the redundancy index for each sensor 110, which quantifies the degree of overlap or duplication in data collected from different sensors. Sensors with high redundancy are deprioritized to conserve energy. Additionally, the key task includes the generation of a semantic criticality index for each sensor 112, which ranks sensors based on their essentiality to the monitoring objective.

After processing the attention scores, redundancy index, and semantic criticality index, the system uses this information to determine an optimal activation schedule 114 through a reinforcement learning (RL) model. The RL model, which resides within the processor, uses these indices to decide which sensors to activate at each time step. It evaluates multiple factors, including data quality, energy efficiency, and redundancy minimization, to compute a schedule that maximizes overall system performance. The RL model then outputs actions representing subsets of sensors to activate at each time step 116, specifying which sensors should be turned on or off.

The activation decisions are implemented by the system, which activates the selected subset of sensors 118 based on the RL model's recommendations. Activated sensors transmit real-time environmental data back to the processing unit via the communication interface for further analysis. Finally, the system updates the attention mechanism and RL model using feedback from sensor performance and collected data 120. Feedback may include information about sensor reliability, energy consumption patterns, and data relevance, which is used to refine the model iteratively. This adaptive feedback loop ensures continuous improvement in scheduling decisions, making the sensor network more efficient and responsive to dynamic environmental conditions.

FIG. 1C shows an example field covered by cluster of sensors and a data collector unit collecting the data from the sensors, according to some embodiments. FIG. 1C represents an example embodiment of how a data collection system for smart agricultural fields, where mobile data collection units traverse a rail system 156 to gather data from distributed sensor clusters. FIG. 1C includes an environment 150 where the rail 156 serves as a structured pathway for the movement of data collection units 158, which may move periodically or aperiodically to collect data.

The mobile data collection unit 158, which may be a robot, drone-like device, or any automated mechanism, moves along the rail 156, establishing communication with the sensor clusters as it passes their vicinity. The data collection units in FIG. 1C may take various forms depending on the operational requirements. One of the implementations involves rail-based robots, like the one shown in FIG. 1C, which are equipped with communication modules to establish a connection with nearby sensor clusters. These robots may use short-range communication technologies such as Zigbee, Bluetooth, or Wi-Fi to retrieve data from clusters within proximity. In scenarios where sensor clusters are located far away from the rail, drones (UAVs) may serve as intermediary data collection units. These drones may fly to remote clusters, collect data, and either relay it to the rail-based robot or directly transmit it to a cloud server. Ground-based autonomous vehicles, such as rovers or robotic tractors, may also be employed for fields without rail infrastructure. These vehicles may navigate uneven terrains and act as versatile alternatives for data collection. A hybrid approach is also possible, where rail-based robots work in conjunction with drones, enabling seamless coverage of both near and distant sensor clusters.

The distance between sensor clusters and data collection units plays a role in determining the mode of communication. For sensor clusters located close to the rail, short-range communication is sufficient to transfer data directly to the mobile unit. In contrast, for clusters situated farther away, intermediary solutions such as drones or mesh networks may be required to bridge the communication gap. Additionally, line-of-sight communication methods, such as RF or optical communication, may be utilized in open fields to facilitate data transfer. For clusters at extreme distances, relay networks may be established, where nearby sensors forward the data in hops until it reaches the mobile unit.

The process of data collection from sensor clusters may be triggered by various mechanisms. In one approach, the mobile unit operates on a pre-defined schedule, collecting data at regular intervals, such as every hour or twice daily, based on the monitoring requirements. Another approach involves event-triggered data collection, where sensors alert the mobile unit when significant changes are detected in the environment, such as variations in soil moisture, temperature fluctuations, or pest activity. Furthermore, sensor clusters may include buffer thresholds to manage data storage. Once a sensor's buffer is nearly full, the system may signal the mobile unit to collect the stored data, preventing data loss. In more advanced setups, dynamic prioritization of data collection can be implemented, where the mobile unit prioritizes clusters based on the criticality of the data. For instance, clusters detecting extreme environmental conditions may be scheduled for immediate data collection.

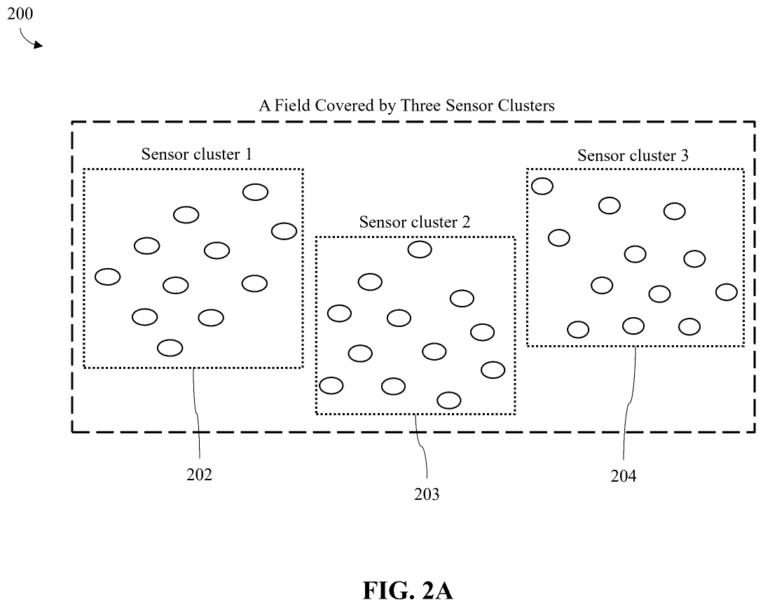

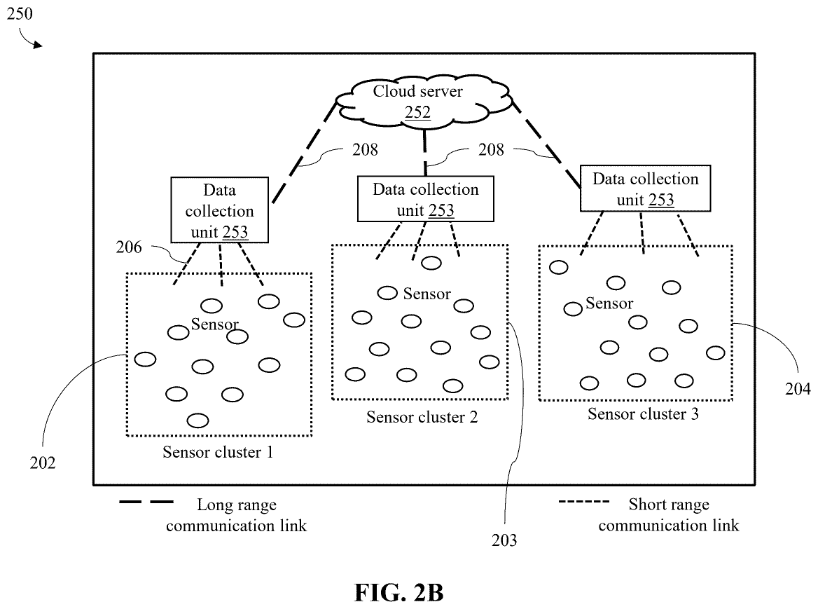

FIG. 2A shows an environment 200 which is an example field covered by three clusters of sensors, according to some embodiments of the present disclosure. FIG. 2A shows a large field covered by three sensor clusters which are sensor cluster 1 202, sensor cluster 2 203 and sensor cluster 3 204, with each cluster consisting of multiple agriculture sensors, which may be different types of sensors such as temperature sensors, soil moisture sensors and crop condition sensors and possibly others like pH sensors, nutrient detection sensors, wind speed sensors, and sunlight intensity monitors. These sensors collectively provide extensive data required for monitoring smart agriculture. The sensor data needs to be collected and processed at cloud servers to obtain useful insights for the best decision making. However, due to cost consideration, agriculture sensors are typically equipped with short range communication technology. As a result, the sensors may not be able to directly communicate with remote cloud servers. As a result, the communication infrastructure is needed to deliver sensor data from sensors to cloud servers. However, one of the challenges is that communication infrastructure may not be available in rural areas.

The field depicted is representative of a large agricultural area, and the system is scalable and adaptable to fields of varying sizes and geographies. It is important to note that the number of clusters is not limited to three; additional clusters may be deployed as required based on field size, sensor density, and the type of crops being cultivated. Each cluster may cover a designated portion of the field and operate independently to some extent, allowing for distributed and monitoring of specific areas. This clustering approach ensures comprehensive field coverage while optimizing sensor usage. The data collected by the sensors in each cluster is transmitted to cloud servers for advanced processing and analysis, enabling the derivation of actionable insights, such as irrigation schedules, pest control strategies, or fertilization plans. However, agriculture sensors may be typically equipped with short-range communication technologies, such as Bluetooth, Zigbee, or Wi-Fi.

In remote or rural areas where robust communication infrastructure is unavailable, alternative solutions may be employed. For instance, UAVs equipped with communication modules may act as mobile data collectors, flying over the sensor clusters to gather data and transmit it to cloud servers when connectivity becomes available. Similarly, ground-based mobile units, such as tractors or rovers, may integrate communication hubs for data collection during their operations across the field.

FIG. 2B is a schematic illustrating a two-tier network architecture with the first-tier network formed by a cluster of sensors and an assigned data collection unit and the second-tier network formed by data collection units and a cloud server, according to some embodiments of the present disclosure. FIG. 2B includes a two-tier network architecture 250 which includes data collection units 253, a cloud server 252 and the sensors clusters 202, 204, and 206 referred in FIG. 2A. Accordingly, some embodiments of the present disclosure provide a dynamic communication infrastructure using the data collection units 253 where the data collection units 253 and sensors form the first-tier networks using short range communication 206 technology, and the data collection units 253 and the cloud server 252 form a second-tier network using long range communication 208 technology. The first-tier networks collect sensor data from sensors and the second-tier network relay the collected data to cloud servers. FIG. 2B demonstrates an example of two-tier network architecture with three first-tier networks formed by three sensor clusters and assigned data collection units.

The first-tier network comprises clusters of sensors distributed across the field, as depicted in FIG. 2A. Each sensor cluster is assigned to a corresponding data collection unit 253 that gathers data as it moves through the field. The data collection units 253 serve as an intermediary node in the data collection process. According to some embodiments, the data collection units 253 may include mobile data collectors such as UAVs, tractors, or ground robots equipped with communication modules. The data collection units 253 traverse the field collecting data from sensors in real-time. The UAVs may be useful for large fields where fixed data collection unit placement may not be feasible or cost-effective. A data collection unit may collect data from required sensors in its assigned cluster using short-range communication 206.

The second-tier network is formed between the data collection units 253 and the cloud server 252. This second-tier is responsible for transmitting aggregated and preprocessed data from the data collection units 253 to the cloud server 252 using long-range communication 208 protocols, such as cellular networks, satellite links, or high-speed wireless technologies. The cloud server 252 performs advanced analytics on the aggregated data, generating actionable insights for field managers or the person in charge.

According to some embodiments, the sensors are divided into clusters based on geometric metric or other metric where each cluster is managed by at least one data collection unit responsible for collecting sensor data and relaying data to cloud servers. Consider a sensor cluster comprising N sensors, denoted as [symbol] ={1, 2, . . . , N} and a data collection unit u is assigned for cluster [symbol] to collect data. During a data collection period, the data collection unit u with capacity constraint in communication and storage may only collect data from a subset of the sensor cluster [symbol] at any time t and therefore, need to decide whether to serve a sensor n, i.e., the n-th sensor in the cluster. Denote U_{u,n,t} as action taken by data collection unit u for sensor n at time t with U_{u,n,t}=1 indicating sensor n being served and U_{u,n,t}=0 indicating otherwise. The data collection unit capacity constraint implies that at any time t, U_{u,n,t} must satisfy the constraint

$$\text{?} {U}_{u , n , t} \leq {U}_{u}^{cap} , \qquad ( 1 )$$

is the maximum data collection capacity of data collection unit u.

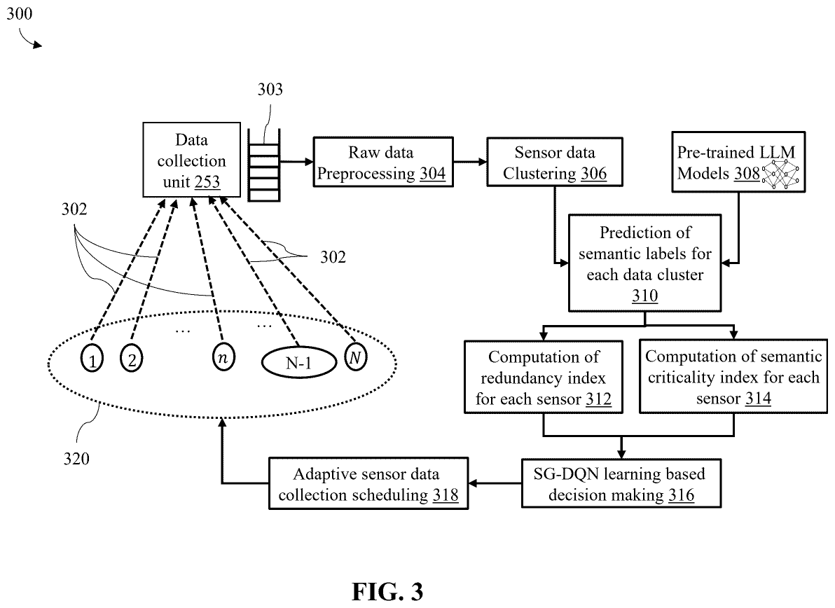

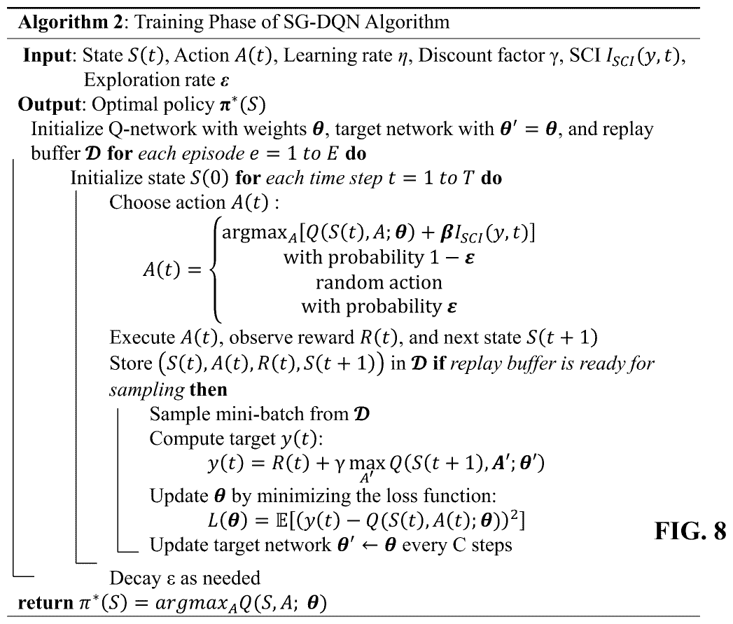

FIG. 3 shows a framework 300 for sensor data collection and processing, according to some embodiments of the present disclosure. The framework 300 includes sensor data collection 302, data buffering 303, raw data preprocessing 304, sensor data clustering 306, prediction of semantic label for each data cluster 310 using pre-trained LLM models 308, computation of redundancy index for each sensor 312, computation of semantic criticality index for each sensor 314, SG-DQN learning-based decision making 316 (explained in detail in FIG. 8) and adaptive sensor data collection scheduling 318. In the framework 300 for data collection and processing, sensor data is collected, and the collected data is processed by LLM models to predict semantic labels for all data clusters. The semantic labels are used to compute redundancy indices (RIs) and semantic criticality indices (SCIs) for sensors. The RIs and SCIs are then used to decide data collection schedules for the next data collection period.

The data collection units 253 perform sensor data collection 302 in a periodic or aperiodic manner. The sensor data collection 302 and sensor data processing are interleaved with collection followed by processing and processing followed by next collection. In each data collection period, the collected sensor data are processed to efficiently schedule next data collection for energy saving on both the data collection units 253 and the sensors in the sensor cluster 320 with the objectives of (1) the important data must be collected, (2) redundant data are not collected, and (3) sensors only wake up for sensing and data transfer. Each data collection unit of the data collection units 253 collects data from the sensors according to schedules designed for the sensors in the sensor cluster 320.

Referring to FIG. 3, the collected sensor data is buffered at 303 till a threshold level of data is available for further processing. Raw data preprocessing 304 is performed on the buffered data to remove outliers and duplicates and the filtered data is scaled through normalization. The normalization scales values to a [−1, 1] range, and contextual augmentation incorporates environment-specific thresholds and context-based factors to enrich the data with domain knowledge, maintaining interpretability and ensuring the model's effectiveness across different cycles. The data buffering 303 and raw data preprocessing 304 may be performed by one or multiple data collection units of the data collection units 253 or by one or more cloud servers. The sensor data clustering 306 classifies the preprocessed data into data clusters using suitable clustering techniques such as K-means clustering for semantic labeling.

For each data cluster, a representative sample of sensor measurements is selected and processed by an LLM of the pre-trained LLM models 308 to predict semantic labels at 310. The predicted labels are aggregated, and the most frequent label is assigned to the entire data cluster. This approach efficiently labels large-scale datasets while preserving semantic consistency within related data points. Accordingly, data measurements belonging to the same data cluster have same label.

Some embodiments incorporate semantic criticality index (SCI) as an innovative metric quantify the criticality of sensor data by combining semantic understanding to prioritize sensor data collection based on its urgency and importance, transforming raw sensor data into actionable priorities for resource allocation. Unlike traditional methods that rely on static thresholds, SCI adapts to dynamically changing agricultural conditions through the utilization of LLM-based semantic embeddings to quantify the significance of sensor data. The SCI modeling uses a three-step process that leverages semantic embeddings, context layers, and an attention mechanism which are described in detail later in the disclosure.

Each sensor measurement is mapped to a high-dimensional space using a fine-tuned LLM, which provides a semantic embedding E(yᵢ) of the data label yᵢ. This embedding represents the criticality and context of each data point, making it more interpretable for downstream processing. Using semantic embedding E(yᵢ) of the data label yᵢ, a redundancy index (RI) and a semantic criticality index (SCI) is computed for each sensor at 312 and 314, respectively. The RI indicates if sensor data contributed by a sensor are redundant in terms of data contributed by other sensors. If yes, the agriculture system does not need to collect data in next data collection period. Details of the computation of the RI and SCI are described later in this disclosure with reference to agricultural data collection example.

The computed RIs and SCIs are then used for decision making 316 for energy efficient sensor data collection scheduling 318, which is formulated as an optimization problem and solved by a novel Semantic-Guided Deep Q-Network (SG-DQN) algorithm—a reinforcement learning algorithm that optimizes energy consumption and resource allocation based on semantic context. The SG-DQN algorithm integrates semantic understanding, derived from LLM-based semantic mapping, with reinforcement learning. By embedding this deep semantic insight, the algorithm dynamically adapts sensor behavior according to the criticality of data and varying environmental conditions. The core objective of this algorithm is to establish highly efficient sense/transmit/sleep scheduling policies for energy-constrained sensors, thereby significantly reducing UAV energy consumption.

### LLM-Powered Agriculture Sensor Data Processing

Some embodiments of the disclosure introduces a novel application of LLMs to enhance the sensor data interpretation in agricultural environments. LLMs such as BERT (Bidirectional Encoder Representations from Transformers) have shown exceptional performance in natural language processing tasks. These capabilities may be extended to agricultural data processing, where sensor measurements, environmental conditions, and crop health indicators may be treated as language, enabling the application of attention mechanisms to place measurements into context and evaluate redundancy and criticality as indicated by the attention scores, where each sensor may be treated as a “word” in a sentence and the data it provides corresponds to the “meaning” of the word and represents its semantic contribution, where a sequence of measurements from multiple sensors over time forms a “sentence” providing a snapshot of the monitored environment. This approach enables capturing complex, non-linear relationships within agricultural data, facilitating more informed decision-making in smart farming systems.

The contextual understanding power of LLMs is leveraged to automatically assign meaningful semantic labels to agricultural data, enhancing the interpretability and usefulness of data. This process begins with a data preparation phase aimed at generating a semantic map that highlights the criticality of crop conditions. Recognizing the inherent challenges in achieving comprehensive data coverage across large-scale agricultural deployments, a strategic sampling approach is developed. In this method, UAVs select sensors for data collection based on a sophisticated analysis of historical patterns of data collection, the time elapsed since the last data collection, and current environmental triggers. This adaptive sampling strategy ensures that data collection remains both efficient and representative of the entire agricultural landscape. Subsequently, the acquired agriculture sensor data undergoes extensive offline preprocessing using high-performance computing resources, which includes cleaning anomalies, advanced feature extraction to identify key agricultural indicators, and contextual augmentation to enrich the dataset with relevant environmental information.

Data acquisition: Data acquisition strategy is based on adaptive sampling optimized for agricultural environments. UAVs collect sensor data according to data criticality, data redundancy, historical patterns, time elapsed since the last data collection, and environmental triggers that indicate changes in conditions. This strategy conserves energy, a critical factor in remote agricultural settings while ensuring data comprehensiveness. For a sensor cluster with N sensors, the dataset is formalized as [symbol] ={d₁, d₂, . . . , d_{|D|}}, where each dₙ is a detailed tuple (sₙ, tₙ, cₙ, νₙ), sₙ is the sensor identifier with location coordinates, tₙ is the timestamp, cₙ is the sensor cluster identifier, and νₙ is a vector of measured values such as temperature, humidity, and soil moisture.

Data preprocessing: The raw data Un is preprocessed through a multi-stage pipeline as

$${v}_{n}^{p} = Norm ( Clean ( {v}_{n} ) ) \cdot Context ( {t}_{n} , {v}_{n} ) , \qquad ( 2 )$$

where outlier filtering removes outliers, normalization scales values to a [−1, 1] range, and contextual augmentation incorporates environment-specific thresholds, growth stage, seasonal adjustments, and spatial context. This approach enriches the data with agricultural domain knowledge, maintaining interpretability and ensuring the model's effectiveness across different agricultural cycles.

Semantic labeling: The semantic labeling leverages pre-trained LLMs (e.g., BERT), extending their natural language processing capabilities to interpret agricultural data. Semantic labeling begins with a labeled subset [symbol] , where data are categorized using agricultural domain knowledge into criticality labels including but not limited to “normal”, “abnormal”, “critical”, and “urgent”. Classification boundaries are defined by

$$Threshold ( p , t ) = f ( p , crop type , growth stage , senson ) , \qquad ( 3 )$$

where p represents a parameter, and the threshold function adjusts values according to crop type, growth stage, and seasonal factors. This dynamic configuration captures complex agricultural relationships that simpler machine learning models struggle to represent.

Model Fine-Tuning: This labeled subset [symbol] is used to fine-tune pre-trained LLMs, adapting them to understand the pattern variations of agricultural sensor data and its semantic implications.

Some embodiments of this disclosure introduce a novel fine-tuning process for a pre-trained LLM using a labeled subset of agricultural sensor readings. The LLM's parameters θ are optimized to predict the semantic label yᵢ for a given sensor measurement

$${v}_{i}^{p}$$

by minimizing following classification loss

$$ℒ = - \frac{1}{N} {\sum }_{i = 1}^{N} {\sum }_{c ∈ {D}_{labeled}} \text{?} \{ {y}_{i} = c \} log P ( {y}_{i} = c \vert {v}_{i}^{p} ; θ ) , \qquad ( 4 )$$

where [symbol] {yᵢ=c} is an indicator function that equals 1 if yᵢ=c and 0 otherwise, and

$$P ( {y}_{i} = c \vert {v}_{i}^{p} ; θ )$$

is the predicted probability that the sensor measurement xᵢ belongs to class c given the collection of all trainable parameters θ. Techniques like cross-entropy loss and Adam optimization are employed to fine-tune θ effectively.

Sensor data labeling: Once fine-tuned, the LLM is used to assign semantic labels to data clusters formed through K-means clustering. For each data cluster Dⱼ, a representative sample of sensor measurements is selected and processed by the LLM. The predicted labels are aggregated, and the most frequent label is assigned to the entire data cluster. Let Dⱼ denote the j-th data cluster, and

$${\{ {x}_{i j} \}}_{i = 1}^{{M}_{j}}$$

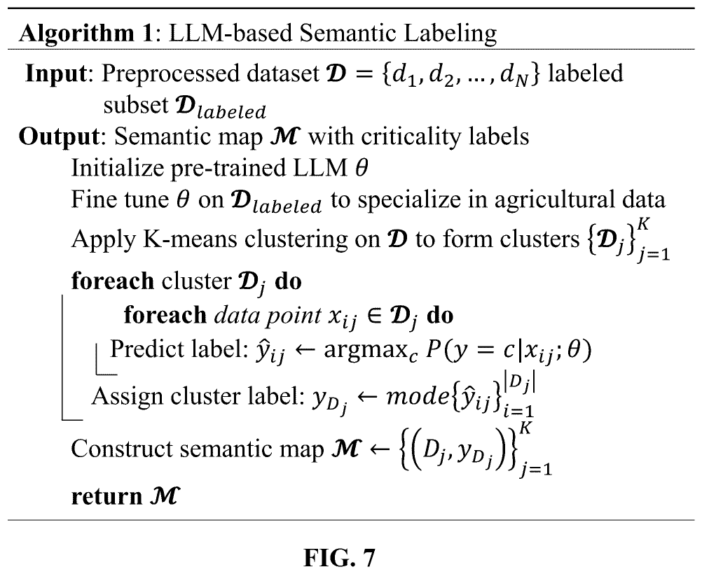

represent the sensor measurements in Dⱼ. The semantic label for data cluster Dⱼ is assigned as follows

$${y}_{{D}_{j}} = mode ( {\{ {\hat{y}}_{i j} \}}_{i = 1}^{{M}_{j}} ) , \qquad ( 5 )$$

where ŷᵢⱼ=argmax_{c}P (y=c|xᵢⱼ;θ) is the predicted label for the i-th measurement in data cluster Dⱼ, and mode(·) returns the most frequent label among the predictions. This method labels large-scale agricultural datasets while preserving semantic consistency within related data points. Accordingly, data measurements belong to same data cluster have same label. FIG. 7 shows a semantic labeling algorithm used by some embodiments.

Semantic criticality index (SCI) of agriculture sensor data: The semantic criticality index (SCI) is an innovative metric quantify the criticality of sensor data by combining semantic understanding to prioritize sensor data collection based on its urgency and importance, transforming raw sensor data into actionable priorities for resource allocation. Unlike traditional methods that rely on static thresholds, SCI adapts to dynamically changing agricultural conditions through the utilization of LLM-based semantic embeddings to quantify the significance of sensor data. The SCI modeling uses a three-step process that leverages semantic embeddings, context layers, and an attention mechanism.
(1) Semantic embedding: Each sensor measurement is mapped to a high-dimensional space using a fine-tuned LLM, which provides a semantic embedding E(yᵢ) of the data label yᵢ. This embedding represents the criticality and context of each data point, making it more interpretable for downstream processing. For example, a sensor measuring temperature during a crop's flowering stage will yield an embedding that reflects its urgency, as temperature variations can impact crop health at this stage. For each semantic label yᵢ derived from data cluster Dⱼ, SCI integrates crop-specific context through dense embeddings computed by the fine-tuned LLM as

$$E ( {y}_{i} ) = {LLM}_{embed} ( {y}_{i} , context ) , \qquad ( 6 )$$

where E(yᵢ) is the semantic embedding for label yᵢ, and the term context includes three layers of context: temporal trends from recent historical data, spatial correlations from neighboring sensors, and domain knowledge like crop-specific thresholds and growth stage requirements. For example, during critical growth stages, the embedding process prioritizes parameters like temperature and humidity, which may have greater relevance than stable factors such as soil pH.
(2) Context Layers (Adding Multi-Layered Agricultural Context): Each semantic embedding is amplified with three context layers: temporal, spatial, and domain-specific to tailor the criticality assessment according to real-time agricultural needs. Temporal Layer incorporates time-based trends, such as growth stages, which help emphasize certain data types during crucial periods (e.g., high temperature during flowering). The spatial Layer considers the arrangement of sensors in the field, allowing SCI to assign higher importance to clusters where changes could indicate widespread issues. The Domain-Specific Layer integrates agricultural knowledge (e.g., cropspecific thresholds or response to environmental stressors) to adapt the SCI calculation dynamically. These context layers ensure that SCI remains flexible and adaptive, responding effectively to complex, evolving conditions.
(3) SCI via Attention Mechanism (Prioritizing Based on Relevance): An attention mechanism inspired by Transformer models can be used to model SCI dynamically. The attention mechanism adjusts SCI based on the relative importance of each sensor's data, allowing the agriculture system to focus on high-impact areas and optimize decision-making and resource allocation in smart farming. This approach is to selectively focus on relevant aspects of the input data, a technique adapted from advances in natural language processing. For data

$${v}_{i}^{p}$$

with the senmatic label yᵢ, its SCI is computed as

$$SCI ( {y}_{i} ) = Attention ( E ( {y}_{i} ) , {S}_{net ,} {H}_{perf} ) , \qquad ( 7 )$$

where Sₙₑₜ represents the network state vector and H_{perf} represents the historical performance vector. The query-key-value attention model is defined as

$$Attention ( E ( {y}_{i} ) , {S}_{n e t} , {H}_{pref} ) = {\sum }_{k} {α}_{k} \cdot {Value}_{k} , \qquad ( 8 )$$

where the query vector Q is derived from the semantic embedding E(yᵢ), and the keys K and values V are derived from the network state and historical performance vectors. The attention weights αₖ are computed as

$${α}_{k} = \frac{exp ( Score ( E ( {y}_{i} ) , {K}_{k} ) )}{{\sum }_{l} exp ( Score ( E ( {y}_{i} ) , {K}_{i} ) )} , \qquad ( 9 )$$

with the score function measuring the relevance of the semantic embedding to the network state and historical performance keys, given by

$$Score ( E ( {y}_{i} ) , {K}_{j} ) = {E ( {y}_{i} )}^{T} {WK}_{j} , \qquad ( 10 )$$

where W is a learnable weight matrix that projects the semantic embedding into the same space as the keys.

Similarity score, redundancy index (RI) and SCI of agriculture sensors: Using semantic embedding E(yᵢ) of the data label yᵢ, a RI and SCI can be computed for each sensor, where RI indicates if sensor data contributed by a sensor are redundant in terms of data contributed by other sensors. If yes, the agriculture system does not need to collect data in next data collection period.

Consider a sensor n with kₙ data clusters, the semantic embedding of a sensor n is defined as

$$E ( n ) = {\sum }_{k = 1}^{{k}_{n}} {w}_{k} E ( {y}_{k} ) , \qquad ( 11 )$$

where wₖ is the importance weight of data cluster Dₖ.

Using a dot-product similarity function, the similarity score for sensor n with respect to sensor m is calculated as

$${Score}_{n , m} = \frac{Query ( E ( n ) ) \cdot Key ( E ( m ) )}{\sqrt{d}} , \qquad ( 12 )$$

where Query and Key vectors can be computed using the existing multi-head transformer attention model introduced by Vaswani et al. in “Attention Is All You Need”, d is the length of Key vector.

Accordingly, the RI of sensor n is defined as

$${RI}_{n} = \frac{1}{N} {\sum }_{m \neq n} {α}_{n , m} , \qquad ( 13 )$$

$$where {α}_{n , m} = soft max ( {Score}_{n , m} ) = \frac{exp ( {Score}_{n , m} )}{{\sum }_{l} exp ( {Score}_{n , l} )}$$

and SCI of sensor n is defined as

$$SCI ( n ) = {\sum }_{m} \frac{exp ( {Score}_{n , m} )}{{\sum }_{l} exp ( {Score}_{n , l} )} \cdot Value ( E ( n ) ) , \qquad ( 14 )$$

where V vector is computed using same transformer attention model.

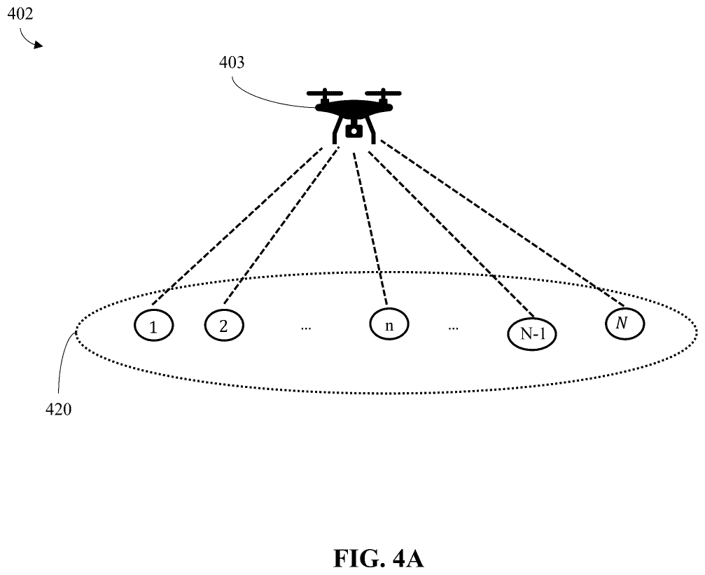

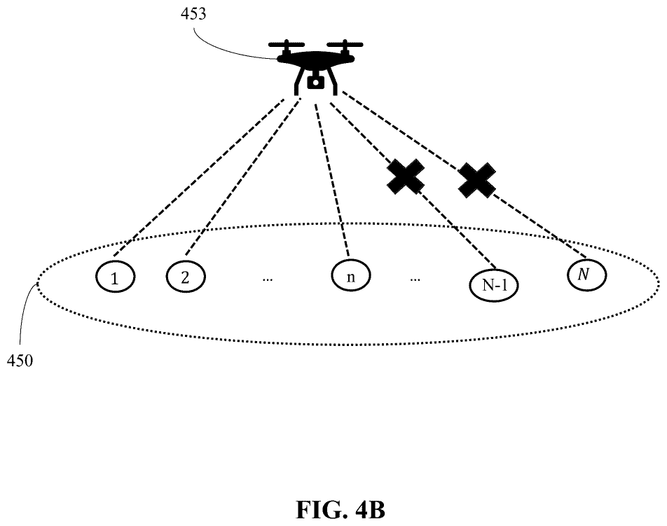

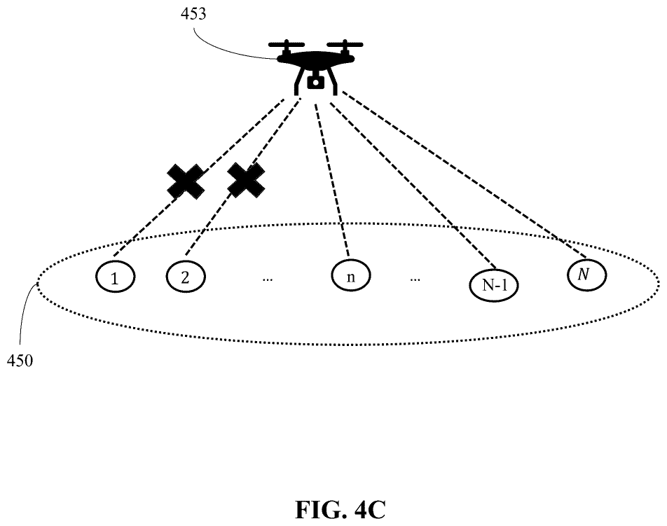

FIG. 4A shows an example of the first-tier network with one UAV and N sensors, according to some embodiments of the present disclosure. FIG. 4A includes a multipoint-to-point topology 402 comprising of N sensors in one or more sensor clusters 420 and an assigned UAV 403 that serves as a data collection unit collecting data from the sensors. It may be contemplated that in some scenarios, the UAV 403 may not have communication links with all sensors in a cluster. As such, the UAV 403 navigates to the sensors to communicate with the sensors. In this network setup, the sensors are deployed across a cluster to monitor environmental parameters such as soil moisture, air quality, temperature, and humidity. Each sensor collects and temporarily stores its data, waiting to establish a communication link with the UAV 403.

The UAV 403, functioning as a mobile data collector, navigates the monitored area, establishing reliable communication links with the sensors in each cluster of the one or more cluster 420. Due to constraints such as terrain, obstacles, or sensor energy levels, the UAV 253 may not have direct communication links with all sensors simultaneously. As a result, the UAV 403 may dynamically adjust its flight path and position to ensure effective data collection from all sensors in its assigned cluster.

### Communication Model for Sensor-UAV Communication

Consider that the N sensors of a sensor cluster [symbol] are deployed in a geometric region with the position known, and a UAV u collects data from the sensor cluster through a ground-to-air channel. In agricultural environments, the communication channels between UAV u and sensors are subject to various propagation phenomena, including line-of-sight (LoS) and non-line-of-sight (NLoS) components. To accurately model these channels, we adopt the Rician fading model, which accounts for a dominant direct path and multiple scattered paths. The Rician fading channel coefficient h_{n,u} between the sensor n and UAV u is expressed as

$${h}_{n , u} = \sqrt{\frac{K}{K + 1}} {h}_{n , u , LoS} + \sqrt{\frac{1}{K + 1}} {h}_{n , u , NLoS} , \qquad ( 15 )$$

where K is the Rician K-factor representing the ratio of the power in the direct path (LoS component) to the power in the scattered paths (NLOS component), h_{n,u,Los} is the deterministic LoS component and can be modeled as

$${h}_{n , u , LoS} = \frac{λ}{4 π {d}_{n , u}} {e}^{j \frac{2 π {d}_{n , u}}{λ}}$$

such that λ is the wavelength of the signal and d_{n,u} is the distance between the sensor n and UAV u, the exponential term represents the phase shift due to the distance d_{n,u}, and h_{n,u,NLoS} is the random NLOS component modeled as a complex Gaussian variable with zero mean and unit variance, i.e., h_{n,u,NLoS}~ [symbol] (0,1).

Assume that agriculture sensor data is transmitted as packets such that the packet generation process at sensor n follows a Poisson distribution with an average rate of λₙ packets per second. The probability of k packets being generated in a time interval of t seconds is defined as follows

$$P ( {N}_{n} ( t ) = k ) = \frac{{( {λ}_{n} t )}^{k} \cdot exp ( - {λ}_{n} t )}{k !} , \qquad ( 16 )$$

where Nₙ(t) is the number of packets generated by sensor n in t seconds. The Signal-to-Noise Ratio (SNR) between sensor n and UAV u can be expressed as

$${SNR}_{n , u} = \frac{{P}_{tx , n} {\vert {h}_{n , u} \vert}^{2}}{{σ}^{2}} , \qquad ( 17 )$$

where σ² represents the noise power at the receiver (UAV u) and P_{tx,n} is transmission power of sensor n. The successful reception of a packet at the UAV u depends on the SNR and the packet loss rate (PLR). The probability of successful packet reception at the UAV u from the sensor n can be expressed as

$${P}_{success , n , u} = 1 - PLR ( {SNR}_{n , u} ) , \qquad ( 18 )$$

where PLR(SNR_{n,u}) is the packet loss rate as a function of the SNR between the sensor n and the UAV u and can be modeled as

$$PLR ( {SNR}_{n , u} ) = 1 - {( 1 - Q ( \sqrt{{aSNR}_{n , u}} ) )}^{L} , \qquad ( 19 )$$

where Q(·) is the Q-function used to calculate the error probability such that

$$Q ( x ) = \frac{1}{\sqrt{2 π}} {\int }_{x}^{∞} {e}^{- {z}^{2} / 2} dz ,$$

α is a modulation-specific constant, and L is the packet length in bits. Then, the aggregated received signal at the UAV u from its assigned sensor cluster is obtained as

$${y}_{u} ( t ) = {\sum }_{n ∈ {𝒞}_{u}} {\sum }_{i = 1}^{{N}_{n} ( T )} {y}_{n , u , i} ( t ) \cdot {1}_{success , n , u , i} \qquad ( 20 )$$

where 1_{success,n,u,i} is an indicator function that equals 1 if the i-th packet from the sensor n is successfully received at the UAV u, and 0 otherwise.

FIG. 4B shows an example of communication connectivity between a UAV 453 and sensors in a sensor cluster 450 in a first-tier network at time T1, according to some embodiments of the present disclosure. FIG. 4B includes an environment which provides insight into the process through which the UAV 453 dynamically establishes communication with various sensors to facilitate real-time data collection in a monitored agricultural field. At time T1, the UAV 453 establishes active communication links with sensors 1, 2, and n. The initiation of this communication may not be arbitrary; instead, it may be triggered by predefined conditions or events. For instance, sensors can send a communication request to the UAV 453 when specific thresholds or criteria are met, such as environmental changes such as drastic fluctuations in soil moisture or temperature, which require immediate data relay. Scheduled data transmission intervals, ensuring periodic updates regardless of environmental changes.

Low local storage capacity within a sensor, prompting a need for offloading data to the UAV 453. UAV proximity detection may be utilized by the sensors to recognize the presence of the UAV 453 within their communication range using signal strength or ping requests or any suitable technique known in the art in this regard. Upon receiving communication requests or identifying sensors within its range, the UAV 453 prioritizes connectivity based on parameters such as the semantic criticality index (SCI), redundancy, and energy levels. Sensors with high SCI values or unique, non-redundant data are given precedence. At time T1, sensors 1, 2, and n are transmitting their data, which may include environmental parameters like soil moisture, crop conditions, or air quality.

The sensor N-1 and sensor N represent potential interactions that may occur at subsequent time steps or in different contexts. These sensors might not be actively transmitting at T1 due to unavailable communication link, lower priority, sufficient existing data, or energy-saving protocols. Adding on, there may be several time intervals for collection of data.

FIG. 4C shows another example of communication connectivity between the UAV 453 and some sensors of the sensor cluster 450 in a first-tier network at time T2, according to some embodiments of the present disclosure. As shown in FIG. 4C, at time T2, the sensor 1 and the sensor 2 are not communicating whereas sensor n, sensor N-1 and sensor N are in communication with the UAV 453.

At T2, sensors 1 and 2, which were active at T1, are now in an inactive or low-energy state. This shift could be due to energy conservation measures, where sensors alternate their active roles within the network to balance energy consumption. For instance, sensor 1 and sensor N-1 may belong to the same type of sensor category, such as soil moisture sensors, and their roles are alternated between T1 and T2 to ensure sustained monitoring while conserving energy. Similarly, sensor N-1, having recorded critical data during T2, takes over the communication role previously handled by sensor 1 at T1, allowing for efficient data collection across different time frames.

The sensors engaged at T2 represent a range of types, including environmental sensors (e.g., temperature and humidity sensors), soil condition sensors (e.g., moisture and pH sensors), and crop condition sensors that provide data on plant health, growth stages, or pest infestations. By activating a subset of sensors, such as sensor N to monitor air quality and sensor N-1 to measure soil pH, the UAV 453 ensures comprehensive coverage while maintaining energy efficiency.

The trigger for communication is determined by various factors, including changes in environmental parameters, predefined communication schedules, and the UAV's prioritization based on the importance of sensor data. For instance, sensors may send communication requests when they detect significant anomalies, such as a drop in soil moisture or a rise in temperature, or when they reach specific thresholds for memory usage or battery levels. The UAV 453 actively polls the sensors, evaluating their readiness to communicate and selectively activating those with the highest priority based on their Semantic Criticality Index (SCI) or redundancy metrics.

At T2, the UAV 453 communicates with the active sensors and integrates their transmitted data into a broader dataset for subsequent processing. This data may be analyzed locally and/or transmitted to a higher-tier system for generating actionable insights. The system further refines the communication patterns in real time by adapting to the feedback received from sensor performance metrics, environmental conditions, and data requirements.

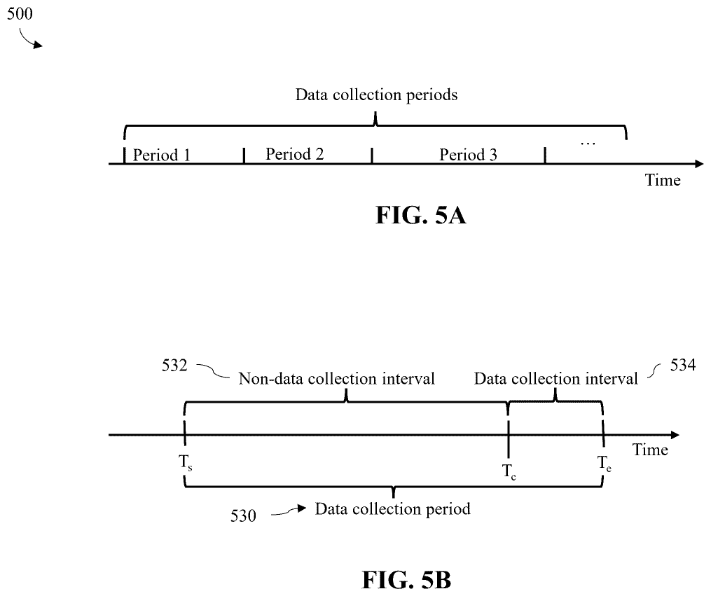

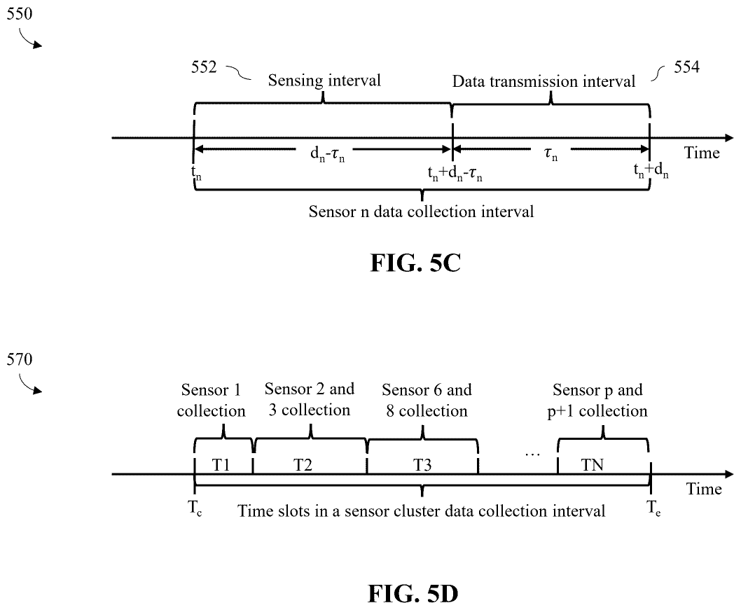

FIG. 5A depicts sensor data collection periods in a smart agriculture system, according to some embodiments. FIG. 5A includes the environment 500 that shows data collection periods, where periods can be periodic or aperiodic. For example, period 1 and period 2 may be of same duration and the data collection in these two periods is therefore periodic. However, period 3 may be of a different duration and as such the data collection in period 3 may be aperiodic with respect to the data collection in period 1 and period 2. According to some embodiments, within each period, data collection by the data collection units 253 of FIG. 3 may be performed at the end of the respective period.

FIG. 5B demonstrates the structure of a data collection period for a sensor cluster, according to some embodiments. The data collection period 530 starts at time instance Tₛ and ends at time instance Tₑ and comprises a non-data collection interval 532 between the time instances Tₛ and Tₑ a data collection interval 534 between the time instances T_{c} and Tₑ. In the non-data collection interval 532, sensors may sleep or perform sensing based on application configuration. The data collection interval 534 starts at time T_{c}. In the data collection interval 534, the assigned data collection unit u collects data from sensors based on the schedules designed for sensors. According to some embodiments, the data collection unit u may only collect data from a set of required or assigned sensors.

FIG. 5C demonstrates the structure of a data collection interval 550 for an individual sensor n, according to some embodiments. The data collection interval 550 starts at time tₙ and ends at time tₙ+dₙ and comprises a sensing interval 552 starting at time t and ending at time tₙ+dₙ−τₙ and a data transmission interval 554 starting at time to +dₙ−τₙ and ending at time tₙ+dₙ. During the sensing interval 552, the sensor n performs sensing of a parameter and generates the corresponding sensor data. The generated sensor data is transmitted to an assigned data collection unit during the data transmission interval 554.

FIG. 5D shows an example structure of a data collection interval 570 for a sensor cluster, according to some embodiments. The data collection interval 570 spans from time T_{c} to Tₑ. The data collection interval 570 may comprise multiple time slots T1, T2, T3, to TN. Within each time slot, a data collection unit u collects data from one or multiple sensors. For example, within time slot T1 the data collection unit u may collect data from sensor 1, whereas within time slot TN, the data collection unit u may collect data from sensors p and p+1.

### SCI Based Agriculture Sensor Activation Scheduling

According to some embodiments, the agriculture data collection may be performed periodically or aperiodically. A data collection period may start at time Tₛ and end at time Tₑ as shown in FIG. 5B, where data collection is performed at the end of period. The data collection process involves five critical time parameters: the start time Tₑ and the duration D for the sensor cluster, the wake-up time ty, the wake-up duration dₙ and the data transmission duration τₙ for each sensor n. These parameters are essential for ensuring UAV u effectively manages its flying path and energy resources while capturing the necessary data from each sensor in the cluster. A sensor n may wake up or be activated at time tₙ, and the sensor n performs sensing for dₙ−τₙ time and then transmits its data to the UAV u for τₙ time. It is critical that outside its wake up interval [tₙ, tₙ+dₙ], the sensor n remains in sleep mode to conserve energy. It is possible that a UAV u can collect data from multiple sensors simultaneously. For example, a UAV u may collect data from sensor 1 in time slot T2, from sensors 2 and 3 in time slot T2, and from sensors 6 and 8 in time slot T3. For each data collection period of a sensor cluster, its duration D is dynamically adjusted based information obtained in previous data collection period such that

$$D = {D}_{p} + Δ D , \qquad ( 21 )$$

where Dₚ is the data collection duration of the previous data collection period and ΔD is calculated to adjust the collection period duration based on the semantic criticality of the data gathered during the previous collection period and to balance the necessity of comprehensive data capture against the imperative of resource conservation and is given by

$$Δ D = {D}_{p} ( f ( Y , {I}_{SCI} ( Y ) ) - 1 ) , \qquad ( 22 )$$

where Y represents the semantic labels of all data clusters, function ƒ(Y, I_{SCI}(Y)) integrates the semantic criticality indices SCI derived from sensor data and defined as

$$f ( Y , SCI ( Y ) ) = max \{ 1 + {γ}_{normal} avg ( SCI ( {y}_{normal} ) ) , exp ( {γ}_{abnormal} ( 1 - max ( SCI ( {y}_{abnormal} ) ) ) ) , 1 + {γ}_{critical} ( 1 - {max ( SCI ( {y}_{critical} ) )}^{2} ) , 1 + \frac{{γ}_{urgent}}{1 + max ( SCI ( {y}_{urgent} ) )} \} ,$$

where the scaling factors γₙₒᵣₘₐₗ, γ_{abnormal}, γ_{critical}, and γ_{urgent} are parameters used to modulate the impact of different semantic criticality levels on scheduling duration. Their specific values are defined through empirical evaluation based on agriculture system requirements and the specific context of the application. The above function employs a monotonically increasing response from normal to urgent conditions, using averages for stability in normal/abnormal states and maximums for quick reactions to critical/urgent situations, thus optimizing resource allocation in UAV-assisted agricultural network.

Through the usage of LLM derived semantic map, adjustments on operational interval of sensor n are computed as follows, aligning with UAV availability and ensuring efficient data collection such that

$${t}_{n} = {T}_{c} + Δ {t}_{n} , \qquad ( 23 )$$

$${d}_{n} = {d}_{n} + Δ {d}_{n} ,$$

$${τ}_{n} = {τ}_{n} + {Δτ}_{n} ,$$

where Δtₙ, Δdₙ and Δτₙ are determined based on the sensor data's semantic criticality, ensuring that each sensor is active only when necessary and transmits the most relevant data.

### Agriculture Sensor Activation Scheduling Problem Formulation

In precision agriculture, the interaction between UAVs and ground sensors must be optimized to enhance both data reliability and energy efficiency. The agriculture sensor data collection scheduling problem is formulated as an optimization framework that leverages novel LLM-derived SCI and RI to prioritize data collection tasks based on their semantic importance. The optimization problem balances energy efficiency with effective scheduling in our UAV-assisted smart agriculture networks. The primary objective is to minimize the total energy consumption of both UAVs and sensors while ensuring successful data transmission. The optimization problem is formally defined as follows,

$${minimize}_{{T}_{c} , D , \hat{t} , \hat{d} , \hat{τ} , {P}_{tx , u}} {E}_{total} - {ω}_{suc} {\sum }_{n = 1}^{N} {P}_{success , n , u} \qquad ( 24 )$$

$$subjectto {SNR}_{n , u} \geq {SNR}_{threshold} , ∀ n ,$$

$${P}_{tx , u} \leq {P}_{max}^{uav} ,$$

$${v}_{min} \leq {v}_{u} \leq {v}_{max} ,$$

$${T}_{c} \leq {t}_{n} \leq {T}_{c} + D - {d}_{n} , ∀ n ,$$

$${τ}_{n} \leq {d}_{n} \leq D - ( {t}_{n} - {T}_{c} ) , ∀ n ,$$

$${\sum }_{n ∈ 𝒞} {U}_{u , n , t} \leq {U}_{u}^{cap} , ∀ t ,$$

where \hat{t}, \hat{d}, \hat{τ} are vectors of tₙ, dₙ, τₙ, respectively, ω_{suc} is a weighting factor used to adjust the relative importance of successful data transmission compared to energy conservation, and Eₜₒₜₐₗ represents the total energy consumption associated with a sensor cluster, encompassing all operational aspects of both UAV u and sensor cluster and is calculated as

$${E}_{total} = {E}_{flight}^{u} + {E}_{comm}^{u} + {\sum }_{n = 1}^{N} ( {E}_{sensing}^{n} + {E}_{sleep}^{n} + {E}_{tx}^{n} ) \qquad ( 25 )$$

and it may be assumed that a UAV is capable of adjusting its transmission power. The optimization problem (25) is solved once the current data collection phase is completed. The decision variables are targeted for the next data collection period.

UAV energy consumption model: The energy consumption of UAV u is a critical factor that directly impacts the efficiency and sustainability of smart agricultural networks. This consumption can be broadly categorized into two primary components: energy consumed on flight and energy used for communication, modeled as

$${E}_{u} = {E}_{flight}^{u} + {E}_{comm}^{u} \qquad ( 26 )$$

Each of these components is further decomposed to account for the unique characteristics of the UAV-assisted smart agriculture networks and the semantic importance of the data being collected.
(1) UAV flight energy consumption: The flight energy consumption represents a significant portion of the UAV's total energy expenditure. This component encompasses the energy required for all aerial maneuvers, including takeoff, navigation to sensor locations, hovering for data collection, and return to the base. As UAVs navigate through the agricultural environment, they continuously adjust their flight patterns based on the terrain, obstacles, and the locations of agriculture sensors. Upon reaching sensor locations, UAVs transition to a hovering mode, maintaining a stable position above the sensors to facilitate reliable data collection. For a UAV u, the flight energy

$${E}_{flight}^{u}$$

is given by

$${E}_{flight}^{u} = {\int }_{{T}_{c}}^{{T}_{c} + D ( SCI ( Y ( t ) , t ) )} {P}_{nav} ( {v}_{u} ( t ) ) dt , \qquad ( 27 )$$

where Pₙₐᵥ(ν(t)) represents the power required for navigation at varying velocities, and the semantic importance factor influences UAV flight energy consumption by minimizing the length of data collection interval D and impacting UAV flight path. For instance, UAVs collect more data in areas with high agricultural significance.
(2) UAV communication energy consumption: Once a UAV u reaches its target sensor areas, it transitions into a stable hovering mode above the sensors and moves only if the communication link becomes unstable. Hovering is essential for establishing a reliable communication link. The communication energy encompasses all energy consumed by the UAV's communication circuits for sending, receiving, and processing signals during data transmission from agriculture sensors. Our model incorporates the complexities of the agricultural environment, including the Rician fading channel to account for both line-of-sight and multipath signal propagation, as well as packet-level transmission dynamics. For a UAV u, its communication energy

$${E}_{comm}^{u}$$

is modeled as

$${E}_{comm}^{u} = {E}_{tx}^{u} + {E}_{rx}^{u} , \qquad ( 28 )$$

$$where {E}_{tx}^{u}$$

is the energy used for transmitting wake-up and control signals to the sensors given by

$${E}_{tx}^{u} = {\sum }_{n = 1}^{N} {P}_{tx , u} {τ}_{c , n} {\vert {h}_{n , u} \vert}^{2} \qquad ( 29 )$$

$$and {E}_{rx}^{u}$$

covers the energy for receiving data from the sensors given by

$${E}_{rx}^{u} = {\sum }_{n = 1}^{N} {P}_{rx , u} {τ}_{n} {\vert {h}_{n , u} \vert}^{2} , \qquad ( 30 )$$

where P_{tx,u} and P_{rx,u} represent the UAV u's transmission and reception power levels, respectively, τ_{c,n} and τₙ are the durations of control signal transmission to sensor n and data reception from sensor n, respectively and |h_{n,u}| denotes the channel coefficient between sensor n and UAV u, reflecting the variable channel conditions that can affect signal propagation and energy consumption. This model accounts for the energy used in both directions of communication: from the UAV to the sensors for control and wake-up signal transmissions and from the sensors to the UAV for sensor data receptions.

Sensor Energy Consumption Model: In UAV-assisted agricultural networks, the process of data collection begins when the UAV u sends a wake-up signal. Upon receiving this signal, a sensor transitions from its sleep or listen mode to active wake-up mode, ready to perform its sensing and data transmission tasks. The energy consumption of an agriculture sensor n is a critical factor that directly impacts the efficiency and sustainability of the agricultural network. This consumption can be broadly categorized into three primary components: sensing energy, transmitting energy and sleep energy. For sensor n, this model is expressed as

$${E}_{n} = {E}_{sensing}^{n} + {E}_{tx}^{n} + {E}_{sleep}^{n} \qquad ( 31 )$$

(1) Sensor sensing energy consumption: The energy consumed by sensor n between two consecutive data collection period is represented by E_{sensing}. Assume that sensors do not sense while they transmit their data to the UAVs. If data collected by a particular sensor is redundant, it may not perform sensing for energy saving. The energy used for sensing is modeled as follows

$${E}_{sensing}^{n} = {\int }_{{t}_{n}}^{{t}_{n} + {d}_{n} - {τ}_{n}} α ( {RI}_{n} ) {P}_{s , n} ( t ) dt , \qquad ( 32 )$$

where α is a threshold function that equals 1 if the redundancy index RIₙ of sensor n is less than a predefined threshold and 0 otherwise, and P_{s,n}(t) is the time-varying sensing power of sensor n, the time parameters tₙ, dₙ and τₙ are derived from the SCI. This model captures the energy dynamics during the active sensing phase.
(2) Sensor Transmission Energy Consumption: The energy consumed by the sensors during data transmission is influenced by the power required for transmitting the data and the semantic importance of the data being sent, modeled as

$${E}_{tx}^{n} = {\int }_{{t}_{n} + {d}_{n} - {τ}_{n}}^{{t}_{n} + {d}_{n}} β ( {SCI}_{n} ) {P}_{tx , n} ( t ) {\vert {h}_{n , u} ( t ) \vert}^{2} dt , \qquad ( 33 )$$

Where β is a threshold function that equals 1 if the redundancy index SCIₙ of sensor n is less than a predefined threshold and 0 otherwise, and P_{tx,n} is the time-varying transmission power required for transmission from sensor n to UAV u.
(3) Sensor Sleep Energy Consumption: The energy consumed during sleep mode is modeled to reflect minimal power usage while maintaining sensor readiness, modeled as

$${E}_{sleep}^{n} = {\int }_{{T}_{s}}^{{T}_{e}} {P}_{sleep , n} ( t ) {δ}_{sleep , n} ( t ) dt , \qquad ( 34 )$$

where P_{sleep,n}(t) is the time-varying sleep power of sensor n, δ_{sleep,n}(t) is a binary function that defines the sleep periods when the sensor n is neither sensing nor transmitting such that

$${δ}_{sleep , n} ( t ) = \{ \begin{matrix}0 , & if {t}_{n} \leq t < {t}_{n} + {d}_{n} \\ 1 , & otherwise\end{matrix} \qquad ( 35 )$$

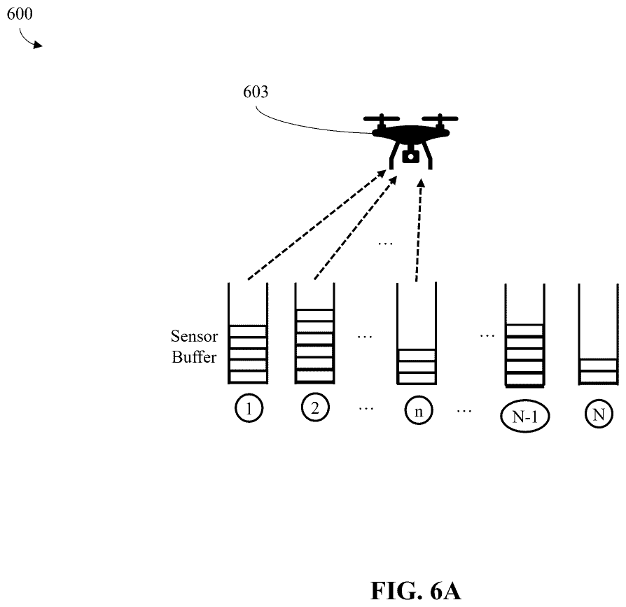

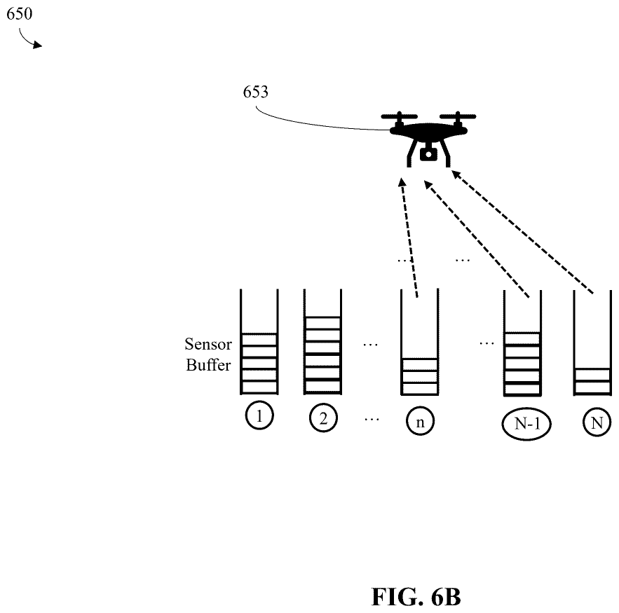

FIG. 6A illustrates an example of the sensors in a sensor cluster that are scheduled for data collection at time T1, according to some embodiments of the present disclosure. FIG. 6A shows an environment 600 which includes a UAV 603 and shows sensors 1 to N scheduled for data collection at time slot T1, where sensors 1, 2 and n participate in data collection. The sensor data collection shown is in a first-tier network during a scheduled time slot T1, highlighting the role of a UAV 603 as a mobile data collector. In this embodiment, the UAV 603 communicates with selected sensors to retrieve buffered data from the sensors 1 to n, enabling efficient and adaptive data acquisition across the monitored area. Each sensor is equipped with a buffer that temporarily stores environmental data, such as soil moisture, temperature, and crop health, which is later transmitted to the UAV 603 during its scheduled communication period. At time slot T1, sensors labeled 1-n, are shown actively transmitting their buffered data to the UAV 603, while other sensors n+1 to N remain inactive to conserve energy. The selection of sensors for communication is based on several factors, including their semantic criticality to the monitoring objectives, available energy levels, and redundancy in the data provided by neighboring sensors. This dynamic scheduling ensures that only the most relevant and energy-efficient sensors are activated during each time slot.

The UAV 603 wirelessly collects data from the scheduled sensors via the communication pathways indicated as dashed lines in FIG. 6A. Once collected, the data may be processed by the UAV 603 or may be forwarded to cloud servers over the second-tier network for analysis and decision-making. For instance, sensors n+1 to N remain inactive during the time slot T1 to conserve energy and may be activated at a subsequent time slot to report critical updates. Conversely, sensors 1 to n may remain active at a previous timeslot but may remain idle in a current time slot to preserve their resources. The sensor buffers and communication processes are designed to adapt to varying conditions, such as the criticality of the data, the UAV's flight path, and the overall system requirements. The sensors involved may include a variety of types, such as soil moisture sensors, air quality monitors, temperature probes, or crop health sensors, ensuring comprehensive monitoring of the agricultural field.

FIG. 6B shows sensors scheduled for data collection at time slot T2, where sensors n to N participate in data collection. As a result, sensor n participates in data collection in both time slots T1 and T2. FIG. 6B illustrates a environment 650 illustrating the communication process in a first-tier network during a scheduled time slot T2, highlighting the dynamic nature of sensor activation for data collection. During the time slot T2, the UAV 653 interacts with a subset of sensors (n to N) to collect buffered data, while other sensors (1 to n-1) remain inactive to conserve energy or reduce redundancy. Each sensor is equipped with a buffer, where environmental data such as soil conditions, temperature, or crop health is temporarily stored before being transmitted during its designated time slot.

At time T2, sensors n to N may be prioritized for data communication based on factors such as the urgency or criticality of their data, their energy availability, and their relevance to the overall monitoring objectives. For instance, sensor N-1, which may have been idle at time T1 to conserve energy, may be turned active in time slot T2, contributing new data to the UAV 653. Similarly, sensor 1, which transmitted data at T1, remains idle at T2, demonstrating the system's ability to rotate sensor activity for optimal energy efficiency.

The UAV 653 establishes wireless connections with the active sensors via the communication pathways shown in the diagram and retrieves data stored in their buffers. This collected data is subsequently transmitted to a second-tier network, such as cloud servers, for detailed analysis. The sensors involved may include a wide variety of devices, such as soil pH sensors, temperature probes, crop health imaging units, or atmospheric sensors, depending on the specific agricultural monitoring requirements. This system exemplifies an energy-aware and scalable approach to data acquisition, ensuring that critical information is collected without compromising the operational longevity of the sensor network.

### Semantic-Guided Deep Q-Network (SG-DQN) Algorithm

Some embodiments provide an innovative LLM-empowered learning algorithm known by Semantic-Guided Deep Q-Network (SG-DQN) to tackle the optimal scheduling problem (25). The algorithm is demonstrated in FIG. 8. This novel algorithm integrates semantic understanding, derived from LLM-based semantic mapping, with reinforcement learning. By embedding this deep semantic insight, the algorithm dynamically adapts sensor behavior according to the criticality of data and varying environmental conditions. The core objective of this novel framework is to establish highly efficient sense/transmit/sleep scheduling policies for energy-constrained sensors, thereby significantly reducing UAV energy consumption. This cutting-edge solution sets a new benchmark in the field, driving the evolution of intelligent, energy-efficient, and context-aware smart agriculture network systems. The scheduling problem (25) is formulated as a Markov Decision Process (MDP), incorporating the LLM-derived SCI and RI.

State Space S: The state space comprises sensor state at time t, defined by {Sₙ(t)} and the state for each sensor n at time t is given by

$${S}_{n} ( t ) = \{ {s}_{n} ( t ) , {E}_{n} ( t ) , SCI ( {y}_{n} ( t ) ) , {T}_{c} , D , {t}_{n} , {d}_{n} , {τ}_{n} \} , \qquad ( 36 )$$

where Sₙ(t) ∈{sense, transmit, sleep} denotes the operational state of the sensor n, Eₙ(t)∈[0, Eₘₐₓ] represents the remaining energy of the sensor n and SCI(yₙ(t))∈[0,1] represents the SCI of the sensor n's data.

Action Space A: The action space defines the possible actions a sensor can take at any time t and denoted by

$${A}_{n} = \{ {a}_{n} ( t ) \vert {a}_{n} ( t ) ∈ \{ sense , transmit , sleep \} \} \qquad ( 37 )$$

State Transition P: Define the state transition function to describe how the state of the sensor n changes in response to the actions taken as it needs to reflect the change in operational modes based on operational parameters and system dynamics and it is described as follows

$${s}_{n} ( t ) = \{ \begin{matrix}sleep , & if {T}_{s} \leq t < {t}_{n} \\ sense , & if {t}_{n} \leq t < {t}_{n} + {d}_{n} - {τ}_{n} \\ transmit , & if {t}_{n} + {d}_{n} - {τ}_{n} \leq t \leq {t}_{n} + {d}_{n} \\ sleep , & if {t}_{n} + {d}_{n} \leq t \leq {T}_{e}\end{matrix} \qquad ( 38 )$$

Thus, the state transits as sleep→sense→transmit→sleep. The state transitions are based on sensor n's current state, energy level, SCI, and its task schedules.

Reward Function with Penalties: The MDP is subject to the constraints inherited from the optimization problem. Integrating constraints as penalties in the reward function of a MDP is a common and effective strategy. This approach allows the model to learn to avoid certain behaviors by experiencing a negative impact on the reward, rather than being strictly forbidden from performing those actions. This method is particularly useful in continuous or complex environments where hard constraints might be intractable to model precisely.

To integrate the constraints into the MDP's reward function, we add penalty terms that reduce the reward based on the violation of constraints. The reward function R(s, a) is formulated as follows

$$R ( s , a ) = - {E}_{total} ( s , a ) - {\sum }_{i = 1}^{m} {λ}_{i} max ( 0 , {g}_{i} ( s , a ) ) \qquad ( 39 )$$

where Eₜₒₜₐₗ is the total energy consumption given in Equation (34) and the gᵢ(s, a) functions are derived directly from the constraints in the optimization problem (33). Each gᵢ (s, a) represents the degree of violation of the i-th constraint, which returns a positive value when the constraint is violated and zero otherwise, and λᵢ is a penalty coefficient for the i-th constraint, indicating the severity of the penalty for violating this constraint. The reward function for the UAV-assisted smart agriculture networks integrates multiple critical aspects to encourage energy conservation, ensure adherence to operational constraints, and optimize data collection schedules based on semantic importance.

Optimization Objective: The SG-DQN formulation allows for adaptive scheduling that integrates semantic criticality indices into energy and data collection optimization strategies in a UAV-assisted agricultural IoT system. The objective is to find an optimal policy π* that maximizes the expected cumulative discounted reward for all sensors and is shown as

$${π}^{*} = arg {max}_{π} E [ {\sum }_{t = 0}^{∞} {γ}_{d}^{t} {\sum }_{n = 1}^{N} R ( {S}_{n} ( t ) , {A}_{n} ( t ) ) ] , \qquad ( 40 )$$

where γ_{d} ∈[0,1) is the discount factor.

SG-Deep Q-Network (SG-DQN): Define a collective Q-function for all sensors in the system such that the proposed SG-DQN approximates the optimal Q-function using a neural network with parameters θ as

$$Q ( S ( t ) , A ( t ) , {I}_{SCI} ( Y ( t ) ) ; θ ) \approx {Q}^{*} ( S ( t ) , A ( t ) , {I}_{SCI} ( Y ( t ) ) ) , \qquad ( 41 )$$

where S(t) and A(t) are the combined states and actions of all N sensors at time t. The neural network architecture consists of multiple layers, including embedding layers for processing semantic labels and fully connected layers for numerical state information. The loss function for training the SG-DQN combines the standard DQN loss with a regularization term to penalize deviations from scheduled wake-up times:

$$L ( θ ) = 𝔼 [ {( r + γ {max}_{{A}^{′}} Q ( S ( t + 1 ) , {A}^{′} ; {θ}^{′} ) - Q ( S ( t ) , A ; θ ) )}^{2} ] + {λ}_{1} 𝔼 [ {\sum }_{n = 1}^{N} log ( 1 + \vert {t}_{n} - {T}_{c} \vert + \vert {d}_{n} - D \vert ) ] \qquad ( 42 )$$

The action selection is guided by both Q-values and semantic importance:

$${A}^{*} = arg {max}_{A} [ Q ( S ( t ) , A , {I}_{SCI} ( Y ( t ) ) ; θ ) + β {I}_{SCI} ( Y ( t ) ) ] , \qquad ( 43 )$$

where β is dynamically adjusted based on LLM insights into crop growth stages and environmental conditions, increasing during critical periods such as flowering or fruit development. The training process involves updating the Q-function parameters using stochastic gradient descent

$$θ ← θ - η {∇}_{θ} L ( θ ) , \qquad ( 44 )$$

where η is the learning rate. The model is updated as needed, incorporating new experiences to adapt to changing agricultural conditions. The replay buffer helps improve learning stability by storing and sampling past experiences during training.

The system updates the scheduling policy for sensors based on the learned Q-function as

$$( {T}_{c} , D , \hat{t} , \hat{d} , \hat{τ} , {P}_{tx , u} ) = arg {max}_{A} Q ( S ( t ) , A , {I}_{SCI} ( Y ( t ) ) ; θ ) \qquad ( 45 )$$

The T_{c}, D, \hat{t}, \hat{d}, \hat{τ} and P_{tx,u} are used to optimize sensor energy consumption by adjusting wake-up times and durations based on the semantic importance of the data and current crop needs.

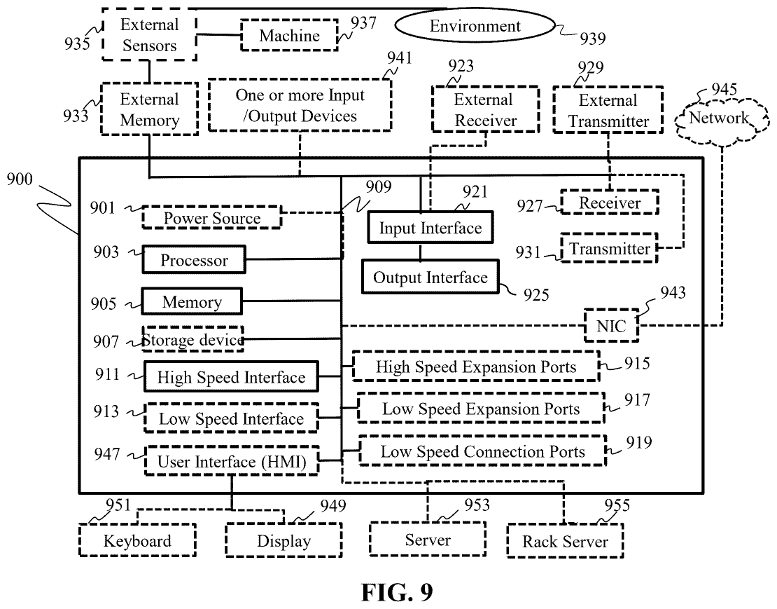

FIG. 9 shows a schematic diagram of some components of a system 900 for optimizing sensor activation scheduling in a distributed sensor network, in accordance with some embodiments of the present disclosure. The system 900 includes a power source 901, a processor 903, a memory 905, a storage device 907, all connected to a bus 909. Further, a high-speed interface 911, a low-speed interface 913, high-speed expansion ports 915 and low speed connection ports 917, can be connected to the bus 909. In addition, a low-speed expansion port 919 is in connection with the bus 909. Further, an input interface 921 can be connected via the bus 909 to an external receiver 923 and an output interface 925. A receiver 927 can be connected to an external transmitter 929 and a transmitter 931 via the bus 909. Also connected to the bus 909 can be an external memory 933, external sensors 935, machine(s) 937, and an environment 939. Further, one or more external input/output devices 941 can be connected to the bus 909. A network interface controller (NIC) 943 can be adapted to connect through the bus 909 to a network 945, wherein data or other data, among other things, can be rendered on a third-party display device, third party imaging device, and/or third-party printing device outside of the system 900.

The memory 905 may store instructions that are executable by the system 900 and any data that can be utilized by the methods and systems of the present disclosure. The memory 905 can include random access memory (RAM), read only memory (ROM), flash memory, or any other suitable memory systems. The memory 905 can be a volatile memory unit or units, and/or a non-volatile memory unit or units. The memory 905 may also be another form of computer-readable medium, such as a magnetic or optical disk.

The storage device 907 can be adapted to store supplementary data and/or software modules used by the system 900. The storage device 907 can include a hard drive, an optical drive, a thumb-drive, an array of drives, or any combinations thereof. Further, the storage device 907 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 903), perform one or more methods, such as those described above.

The system 900 can be linked through the bus 909, optionally, to a display interface or user Interface (HMI) 947 adapted to connect the system 900 to a display device 949 and a keyboard 951, wherein the display device 949 can include a computer monitor, camera, television, projector, or mobile device, among others. In some implementations, the system 900 may include a printer interface to connect to a printing device, wherein the printing device can include a liquid inkjet printer, solid ink printer, large-scale commercial printer, thermal printer, UV printer, or dye-sublimation printer, among others.

The high-speed interface 911 manages bandwidth-intensive operations for the system 900, while the low-speed interface 913 manages lower bandwidth-intensive operations. Such an allocation of functions is an example only. In some implementations, the high-speed interface 911 can be coupled to the memory 905, the user interface (HMI) 945, and to the keyboard 951 and the display 949 (e.g., through a graphics processor or accelerator), and to the high-speed expansion ports 915, which may accept various expansion cards via the bus 909. In an implementation, the low-speed interface 913 is coupled to the storage device 907 and the low-speed expansion ports 917, via the bus 909. The low-speed expansion ports 917, which may include various communication ports (e.g., USB, Bluetooth, Ethernet, wireless Ethernet) may be coupled to the one or more input/output devices 941. The system 900 may be connected to a server 953 and a rack server 955. The system 900 may be implemented in several different forms. For example, the system 900 may be implemented as part of the rack server 955.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a FIG. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A computer-implemented method for optimizing sensor activation scheduling in a distributed sensor network, the method comprising:
receiving input data from a plurality of sensors distributed across a monitored area, wherein each sensor of the plurality of sensors provides measurements of one or more environmental parameters of the monitored area;
generating a plurality of feature vectors corresponding to the input data, wherein each feature vector of the plurality of feature vectors includes sensor-specific attributes including one or a combination of values of the measurements, semantic criticality of the measurements, redundancy index of the measurements, spatial metadata associated with a corresponding sensor, temporal trends associated with the measurements, sensor energy level, and operational characteristics of the corresponding sensor;
applying an attention mechanism to the plurality of feature vectors to:
compute attention scores for each sensor of the plurality of sensors by comparing sensor-specific feature vectors of the plurality of feature vectors to a global context vector based on a similarity function,
compute redundance index for each sensor of the plurality of sensors from the attention scores to access overlap of a respective sensor with a subset of sensors of the plurality of sensors, and
generate a semantic criticality index for each sensor indicating criticality of a respective sensor to a monitoring objective;
executing a reinforcement learning model to determine an optimal activation schedule for the plurality of sensors based on the redundance index and the semantic criticality index of each sensor of the plurality of sensors,
wherein the reinforcement learning model defines states of the plurality of sensors based on one or more of the attention scores of the plurality of sensors, the sensor energy level of each sensor of the plurality of sensors, or historical activation schedules of the plurality of sensors,
wherein the reinforcement learning model outputs actions representing selection of subsets of sensors of the plurality of sensors to activate at each time step, and
wherein the selection of the subset of sensors maximizes a reward function that accounts for data quality, energy efficiency, and redundancy minimization in the distributed sensor network;
activating the selected subset of sensors based on the output of the reinforcement learning model; and
iteratively updating the attention mechanism and reinforcement learning model using feedback from sensor performance and collected data to improve scheduling efficiency.

2. The method of claim 1, wherein the attention mechanism computes the attention scores using a transformer-based architecture with multi-head attention to evaluate multiple aspects of sensor relevance including spatial coverage, temporal variability, and correlation with neighboring sensors of the plurality of sensors.

3. The method of claim 1, wherein the redundancy indices and semantic criticality indices are computed using semantic labels.

4. The method of claim 1, wherein the reinforcement learning model is a semantic-guided deep Q-learning network (SG-DQN) trained with a reward function that penalizes:
activation of redundant sensors among the plurality of sensors,
excessive energy consumption in the distributed sensor network, and
failure to activate sensors in specific regions of the monitored area.

5. The method of claim 1, wherein the plurality of sensors perform monitoring objectives by sensing environmental parameters and participate in wireless networks dynamically formed by at least one sensor cluster and at least one unmanned aerial vehicle (UAV) of a plurality of UAVs for sensor data transfer, wherein the plurality of UAVs act as dynamic data collectors, wherein each dynamic network operates only during sensor data collection phase for energy saving, and wherein at least one sensor of the plurality of sensors and at least one UAV of the plurality of UAVs communicate using a Rician channel model with fading channel coefficient proportional to a ratio of power in a direct path between the at least one sensor and the at least one UAV to power in scattered path between the at least one sensor and the at least one UAV.

6. The method of claim 1, wherein a dataset for a sensor cluster comprises a datapoint corresponding to each sensor in the sensor cluster, wherein the datapoint of a corresponding sensor is a detailed tuple of an identifier of the corresponding sensor, a timestamp associated with the datapoint, a cluster identifier of the corresponding sensor cluster, and a vector of critical environmental parameters measured by the corresponding sensor.

7. The method of claim 6, further comprising:
preprocessing the vector of critical environmental parameters as raw data through a multi-stage pipeline to obtain preprocessed dataset, wherein the multistage pipeline comprises:
data outlier filtering to remove outliers from the raw data;
data normalization to scale values in the filtered raw data to a [−1, 1] range; and
contextual augmentation that incorporates environment-specific thresholds, growth stage, seasonal adjustments, and spatial context.

8. The method of claim 7, wherein the preprocessed dataset is classified into data clusters using K-means clustering for semantic labeling, and wherein a semantic label yᵢ is assigned to each data cluster Dᵢ.

9. The method of claim 8, further comprising generating, for each semantic label yᵢ, a semantic embedding E(yᵢ) using a fine-tuned large language model (LLM) as
$$E ( {y}_{i} ) = {LLM}_{embed} ( {y}_{i} , context ) ,$$
where E(yᵢ) includes additional environmental and sensor-specific information, enriching the embedding with agricultural context.

10. The method of claim 9, further comprising generating semantic embedding of each sensor in a sensor cluster, based on the semantic embedding of a corresponding semantic label and an importance weight of a data cluster associated with the corresponding sensor.

11. The method of claim 10, further comprising computing similarity scores for sensor n of the plurality of sensors with respect to a sensor m of the plurality of sensors as
$${Score}_{n , m} = \frac{Query ( E ( n ) ) \cdot Key ( E ( m ) )}{\sqrt{d}} ,$$
where E(m) is the semantic embedding of a sensor m of the plurality of sensors and wherein Query and Key vectors are computed using a multi-head transformer attention model, and d is the length of the Key vector.

12. The method of claim 11, further comprising computing the redundancy index (RI) for a sensor n of the plurality of sensors as
$${R}_{n} = \frac{1}{N} {\sum }_{m \neq n} {α}_{n , m} , where {α}_{n , m} = \frac{exp ( {Score}_{n , m} )}{{\sum }_{l} exp ( {Score}_{n , l} )} .$$

13. The method of claim 11, further comprising computing the semantic criticality index (SCI) for a sensor n of the plurality of sensors as
$$SCI ( n ) = {\sum }_{m} \frac{exp ( {Score}_{n , m} )}{{\sum }_{l} exp ( {Score}_{n , l} )} \cdot Value ( E ( n ) ) ,$$
where E(n) is the semantic embedding of the sensor n and wherein Value vector is computed using the transformer attention model.

14. A system for optimizing sensor activation scheduling in a distributed sensor network, the system comprising:
a memory module storing historical sensor data, learned policies, and system parameters; and
a processor configured to:
implement an attention mechanism to compute relevance scores for a plurality of sensors that monitor environmental parameters and transmit measurements;
execute a reinforcement learning model to generate sensor activation schedules for the plurality of sensors, based on the relevance scores, wherein the reinforcement learning model defines states of the plurality of sensors based on the computed relevance scores, sensor energy levels, or historical activation schedules of the plurality of sensors, and wherein the reinforcement learning model outputs actions representing at least one subset of sensors of the plurality of sensors to activate at each time step that maximize a reward function that accounts for data quality, energy efficiency, and redundancy minimization; and
transmit activation signals to the at least one subset of sensors of the plurality of sensors.

15. The system of claim 14, wherein the processor is further configured to activate the selected at least one subset of sensors for sensor data collection, wherein a sensor data collection period for the at least one subset of sensors is specified by a start time Tₛ and an end time Tₑ, wherein each sensor data collection period comprises a non-data collection interval and a data collection interval, wherein the data collection interval starts at time T_{c} and ends at the end time Tₑ with duration D defined as
$$D = {D}_{p} + Δ D ,$$
where Dₚ is previous data collection duration and ΔD is calculated to adjust the current collection period duration based on the semantic criticality of data gathered during a previous data collection period to balance the necessity of comprehensive data capture against the imperative of resource conservation.

16. The system of claim 14, wherein the processor is configured to execute the reinforcement learning model to generate the sensor activation schedules by solving an optimization problem formulated as
$$\begin{matrix}{minimize}_{{T}_{c} , D , \hat{t} , \hat{d} , \hat{τ} , {P}_{t x u}} & {E}_{total} - {ω}_{suc} {\sum }_{n = 1}^{N} {P}_{success , n , u} \\ subject to & {SNR}_{n , u} \geq {SNR}_{threshold} , ∀ n , \\ & {P}_{tx , u} \leq {P}_{max}^{uav} , \\ & {v}_{min} \leq {v}_{u} \leq {v}_{max} , \\ & {T}_{c} \leq {t}_{n} \leq {T}_{c} + D - {d}_{n} , ∀ n , \\ & {τ}_{n} \leq {d}_{n} \leq D - ( {t}_{n} - {T}_{c} ) , ∀ n , \\ & {\sum }_{n ∈ 𝒞} {U}_{u , n , t} \leq {U}_{u}^{cap} , ∀ t ,\end{matrix}$$
where T_{c} is a data collection start time and D is a data collection duration for a sensor cluster, \hat{t}, \hat{d}, \hat{τ} are vectors of wake-up time tₙ, wake-up duration dₙ and data transmission duration τₙ of sensor n, respectively, ω_{suc} is a weighting factor for adjusting the relative importance of successful data transmission compared to energy conservation, P_{success,n,u} is success communication probability between sensor n and a data collection device u, U_{u,n,t} is an action taken by the data collection device u for sensor n at time t with U_{u,n,t}=1 indicating sensor n being served and U_{u,n,t}=0 indicating otherwise,
$${U}_{u}^{aap}$$
is the maximum data collection capacity of UAV u, and SNR corresponds to signal to noise ratio.

17. The system of claim 16, wherein the optimization problem is formulated as a Markov Decision Process (MDP) and solved by a Semantic-Guided Deep Q-Network (SG-DQN) trained to find an optimal policy that maximizes an expected cumulative discounted reward for all sensors.

18. A system for optimizing sensor activation scheduling in a distributed sensor network, the system comprising:
circuitry configured to:
receive input data from a plurality of sensors distributed across a monitored area, wherein each sensor of the plurality of sensors provides measurements of one or more environmental parameters of the monitored area;
generate a plurality of feature vectors corresponding to the input data, wherein each feature vector of the plurality of feature vectors includes sensor-specific attributes including one or a combination of values of the measurements, semantic criticality of the measurements, redundancy index of the measurements, spatial metadata associated with a corresponding sensor, temporal trends associated with the measurements, sensor energy level, and operational characteristics of the corresponding sensor;
apply an attention mechanism to the plurality of feature vectors to:
compute attention scores for each sensor of the plurality of sensors by comparing sensor-specific feature vectors of the plurality of feature vectors to a global context vector based on a similarity function,
compute redundance index for each sensor of the plurality of sensors from the attention scores to access overlap of a respective sensor with a subset of sensors of the plurality of sensors, and
generate a semantic criticality index for each sensor indicating criticality of a respective sensor to a monitoring objective;
execute a reinforcement learning model to determine an optimal activation schedule for the plurality of sensors based on the redundance index and the semantic criticality index of each sensor of the plurality of sensors,
wherein the reinforcement learning model defines states of the plurality of sensors based on one or more of the attention scores of the plurality of sensors, the sensor energy level of each sensor of the plurality of sensors, or historical activation schedules of the plurality of sensors,
wherein the reinforcement learning model outputs actions representing selection of subsets of sensors of the plurality of sensors to activate at each time step, and
wherein the selection of the subset of sensors maximizes a reward function that accounts for data quality, energy efficiency, and redundancy minimization in the distributed sensor network;
activate the selected subset of sensors based on the output of the reinforcement learning model; and
iteratively update the attention mechanism and reinforcement learning model using feedback from sensor performance and collected data to improve scheduling efficiency.

19. The system of claim 18, wherein the attention mechanism computes the attention scores using a transformer-based architecture with multi-head attention to evaluate multiple aspects of sensor relevance including spatial coverage, temporal variability, and correlation with neighboring sensors of the plurality of sensors.

20. The system of claim 18, wherein the redundancy indices and semantic criticality indices are computed using semantic labels.
